(19) United States
(12) Patent Application Publication
(10) Pub. No.: US 2026/0350386 A1
(43) Pub. Date: Nov. 5, 2026

(54) DYNAMIC SUPERVISED NEURAL DISTRIBUTION FUNCTION MACHINE LEARNING SYSTEM

(71) Applicant: ADAPTIVE COMPUTATION LLC, Glendora, CA (US)

(72) Inventors: TUAN A. DUONG, La Verne, CA (US); QUANG NHAN DUONG, La Verne, CA (US)

(73) Assignee: ADAPTIVE COMPUTATION LLC, Glendora, CA (US)

(21) Appl. No.: 19/560,015

(22) Filed: Mar. 7, 2026

Related U.S. Application Data
(63) Continuation of application No. 18/091,081, filed on Dec. 29, 2022.

(51) Int. Cl. G06N 3/08; G06N 3/045; G06N 3/084

(52) U.S. Cl. CPC G06N 3/08; G06N 3/045; G06N 3/084

(57) ABSTRACT

The present disclosure relates to a dynamic supervised and neural distribution machine learning system. In contrast to existing ML approaches, DNDF accommodates a whole data structure via a neural network distribution function from which a decision boundary is born out. In particular, a neural network learning algorithm is used to extract a decision boundary while a neural distribution function is a neural data distribution approach wherein one or more decision boundaries are extracted among various distributions. Other aspects may be described and/or claimed.

### CROSS-REFERENCE TO RELATED APPLICATIONS

This is a continuation in part of a U.S. patent application Ser. No. 18/091,081, titled DYNAMIC NEURAL DISTRIBUTION FUNCTION MACHINE LEARNING ARCHITECTURE; filed on Dec. 29, 2022; published on Jul. 4, 2024, the contents of each application in their entirety are herein incorporated by reference.

### TECHNICAL FIELD

The present disclosure is generally related to computing arrangements based on biological models, computing arrangements based on specific mathematical models, hardware and software implementations of artificial intelligence (AI), machine learning (ML), and neural networks, and in particular, to dynamic supervised neural distribution function machine learning architectures and systems.

### BACKGROUND

Machine learning (ML) is the study of computer algorithms that improve automatically through experience and by the use of data. In general, machine learning involves creating a statistical model (or simply a “model”), which is configured to process data to make predictions and/or inferences. ML algorithms build models using sample data (referred to as “training data”) and/or based on past experience in order to make predictions or decisions without being explicitly programmed to do so.

The concepts of decision boundary's (DB) have been the subject of much research in ML, and almost every class in ML and neural networks (NNs) discusses this concept (see e.g., Duda et al., Pattern Classification and Scene Analysis, New York, Wisley (1973)). DB is a well-set mathematical foundation to establish a hyperplane or non-linear hyperplane to separate between classes. In ML, a classifier may partition an underlying vector space into two sets, one for each class. The classifier will classify all the points on one side of the decision boundary as belonging to one class and all those on the other side as belonging to the other class. Due to this establishment, data samples of each class where they are in the neighbor of another can play a key role where the rest of data are irrelevant. From a data science perspective, every data item must play some role in this decision, regardless data that are mingling with noise.

The support vector machine (SVM) is a well-known technique to separate between two classes (see e.g., Cortes et al., “Support-Vector Networks”, Machine Learning 20, no. 3, pp. 273-297 (1995)). From a mathematical perspective, the DB of an SVM approach can be considered as an optimal DB, but not representable due to concentrating into relatively small data samples into respective data sets for each class that are interfacing between classes. In other words, there are several data points for each class, but the DB produced by SVM only uses a few data points to represent them, and therefore, the SVM DB cannot capture the whole set of data points forming the data structure of each class. This may be referred to as a “missing data structure.” For example, SVM indicates only a few data points in interfacing between two classes that are decided for the DB and the rest of the data samples play no role in the DB. This can lead to the misinterpretation of a few samples data, which is equivalent to more data behind its interface. This suggests that it can be an insufficient approach and provides ineffective generalization feature where whole data sets are not representable. In a sample space, DB can be sub-optimal and may introduce errors when more data and/or new types of samples arrive at some time later.

### SUMMARY

In one aspect, the present disclosure relates to a dynamic supervised and neural distribution machine learning system. In certain embodiments, the dynamic supervised and neural distribution machine learning system includes: a sensory circuitry, an input and output device, and a dynamic supervised and neural distribution machine learning system controller.

In certain embodiments, the sensory circuitry generates a set of input patents for the dynamic supervised and neural distribution machine learning system controller to perform machine learning. The input and output device receives the set of input patents from the sensor circuitry and transmits the set of input patents received to the dynamic supervised and neural distribution machine learning system controller for processing.

In certain embodiments, the dynamic supervised and neural distribution machine learning system controller includes: a processor, a DDR RAM, and a non-volatile memory. The DDR RAM supports operations of the processor, the non-volatile memory stores an operating system, and computer executable instruction. The computer executable instructions include a Neural Distribution Functions Modul, a Competition Function Modul, a Comparator Module, and a Gain Adjuster Module. When executed on the processor, the computer executable instructions cause the processor to perform one or more of flowing operations:
generating, by the Neural Distribution Functions Module, a set of neural distribution functions (NDFs) that are independent of one another, wherein during each iteration of a learning process until convergence is reached, each NDF in the set of NDFs receives an input pattern from the sensor circuitry through the input and output device and generates a candidate output in a set of candidate outputs based on the input pattern;
selecting, by the Competition Function Module connected to the set of NDFs, a candidate output from among the set of candidate outputs during each iteration;
comparing, by the Comparator Modul, the selected candidate output with a target pattern to obtain an error value;
adjusting, by the Gain Adjuster Module connected to the comparator and the set of NDFs, respective neural gains of corresponding NDFs in the set of NDFs when the error value is greater than a threshold; and
feeding, by the Gain Adjuster Module connected to the comparator and the set of NDFs, the adjusted neural gains to the corresponding NDFs, wherein the adjusted neural gains are for generation of a next set of candidate outputs during a next iteration of the learning process.

In certain embodiments, the set of NDFs are learned independently of one another using a cascade error projection (CEP) learning algorithm.

In certain embodiments, each NDF in the set of NDFs includes a decision boundary (DB), and each NDF is configured to classify data according to its DB.

In certain embodiments, each NDF is configured to generate the candidate output to include its DB and one or more classified datasets.

In certain embodiments, the DB of each NDF is derived using the CEP learning algorithm.

In certain embodiments, the set of NDFs are individual sub-networks that are part of a super-network, and wherein the learning process is: a training phase for training the super-network, wherein the input pattern and the target pattern are part of a training dataset; or the learning process is a testing phase for testing and validating the super-network, wherein the input pattern and the target pattern are part of a test dataset.

In certain embodiments, the super-network is a neural network (NN) including one or more of an associative NN, autoencoder, Bayesian NN (BNN), dynamic BNN (DBN), CEP NN, compositional pattern-producing network, convolution NN (CNN), deep CNN, deep Boltzmann machine, restricted Boltzmann machine, deep belief NN, deconvolutional NN, feed forward NN (FFN), deep predictive coding network, deep stacking NN, dynamic neural distribution function NN, encoder-decoder network, energy-based generative NN, generative adversarial network, graph NN, multilayer perceptron, perception NN, linear dynamical system (LDS), switching LDS, Markov chain, multilayer kernel machines, neural Turing machine, optical NN, radial basis function, recurrent NN, long short term memory network, gated recurrent unit, echo state network, reinforcement learning NN, self-organizing feature map, spiking NN, transformer NN, attention NN, self-attention NN, and time delay NN.

In certain embodiments, the competition function includes one or more of a maximum function, a minimum function, a folding function, a radial function, a ridge function, softmax function, a maxout function, an arg max function, an arg min function, a ramp function, an identity function, a step function, a Gaussian function, a logistic function, a sigmoid function, and a transfer function.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the present disclosure, and features and benefits thereof, and together with the written description, serve to explain the principles of the present invention. Wherever possible, the same reference numbers are used throughout the drawings to refer to the same or like elements of an embodiment, and wherein:

FIG. 1 schematically shows an exemplary Cascade Error Projection (CEP) architecture according to certain embodiments of the present disclosure;

FIG. 2 shows an exemplary procedure to be used to practice dynamic supervised and neural distribution machine learning according to certain embodiments of the present disclosure;

FIG. 3 shows an exemplary Dynamic Neural Distribution Function (DNDF) architecture according to certain embodiments of the present disclosure;

FIG. 4 depicts an exemplary DNDF architecture with a feedback mechanism according to certain embodiments of the present disclosure;

FIG. 5 shows an exemplary procedure to be used to practice dynamic supervised and neural distribution machine learning according to certain embodiments of the present disclosure;

FIG. 6 shows a data set including red class data points and blue class data points, a neural distribution, and a corresponding classification results including red class data points and blue class data points according to certain embodiments of the present disclosure;

FIG. 7 shows step 1 of the additive class learning (ACL) study according to certain embodiments of the present disclosure;

FIG. 8 shows step 2 of the ACL study adding a new blue class data set according to certain embodiments of the present disclosure;

FIG. 9 shows step 3 of the ACL study involving adding another new class and learning its distribution according to certain embodiments of the present disclosure;

FIG. 10 shows step 4 of the ACL study involving adding another new class and learning its distribution according to certain embodiments of the present disclosure;

FIG. 11 shows an exemplary update learning adding a new dataset to the red class data set according to certain embodiments of the present disclosure;

FIG. 12 shows aspects of a first non-linear sample data (NSD) study that was performed to show its superiority for autonomy over Support Vector Machine (SVM) according to certain embodiments of the present disclosure;

FIG. 13 shows aspects of a second NSD study that was performed to show that dynamic supervised learning (DSL) is well suited to autonomous learning when the training data sets are not well separable according to certain embodiments of the present disclosure;

FIG. 14 depicts an exemplary neural network (NN) having input newtons and output neurons according to certain embodiments of the present disclosure; and

FIG. 15 illustrates an exemplary dynamic supervised neural distribution function machine learning system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

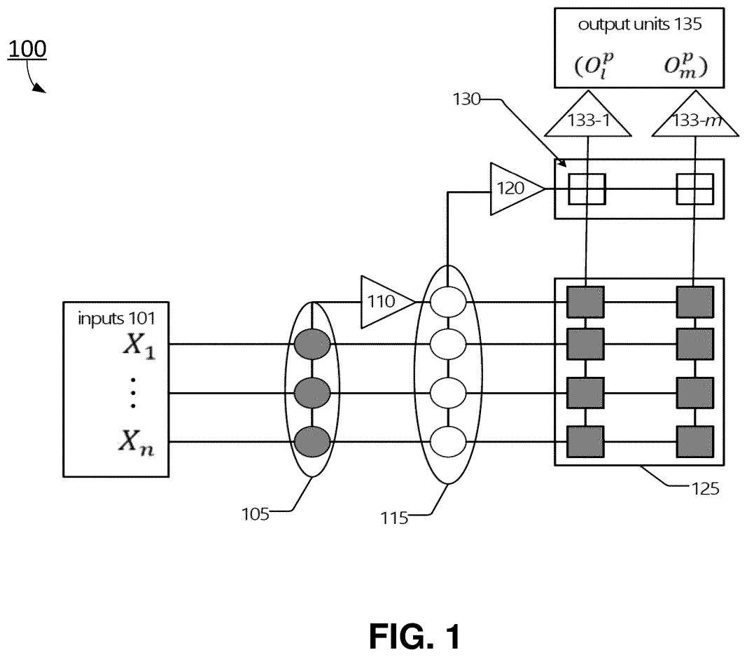

The present disclosure will now be described more fully hereinafter with reference to the accompanying drawings FIGS. 1 through 15, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

### 1. Dynamic Neural Distribution Function Aspects

The concept of decision boundaries (DBs) has been used for many AI/ML tasks, such as classification, detection, recognition, and identification. The DB can be difficult to adapt to new classes of objects or events unless the DB is dismantled and restarted over again. From a data analysis perspective, one does not need all data sets of the same class to determine a DB; rather, a DB can be determined using a few samples at the border with another class. Therefore, a DB may not optimally represent the whole data set. Conventional SVM techniques provide a good example for this concern where only a few data samples are used to determine a DB.

For example, the type of DBs that a backpropagation (backprop) based NN or perceptron can learn is determined by the number of hidden layers the NN has. If there are no hidden layers, then such NNs can only learn linear problems. If there is one hidden layer, then such NNs can learn any continuous function and can have an arbitrary DB. SVMs find a hyperplane that separates the feature space into two classes with the maximum margin. If the problem is not originally linearly separable, the SVM requires a kernel method to be used to provide linearly separability by increasing the number of dimensions. Thus, a general hypersurface in a small dimension space is turned into a hyperplane in a space with much larger dimensions, which may require a relatively large amount of computational resources.

By contrast, neural distribution functions (NDFs), such as the Dynamic Neural Distribution Function (DNDF) aspects discussed herein, can be used to solve the aforementioned DB-related issues. The DNDF aspects discussed herein inherit and accumulate every sample of individual classes to attempt containing it/them within its own distribution. Each NDF is obtained independently and sequentially at a time, without competing with others NDFs and/or without relying on learned previously classes (or classifications). The NDFs are learned using sample data structures and are extracted via an NN learning algorithm to establish their own distributions. The competition between their own distributions is derived to provide a DB as a passive action for a sufficient solution. When the learning landscape becomes dense and crowded (e.g., when the classes outnumber the input dimensions), the new arriving classes will self-adjust their learning gains to meet the learning desires or goals.

The DNDF aspects discussed herein have been shown to successful validate the benchmark-XOR problem, sequential adding learning (SAL) where DNDF learns or updates of one class samples to others without being aware of any learned previously, and non-linear class learning (NCL) basic where SVM faces its difficulty in autonomous learning. The DNDF aspects discussed herein enable cognitive mechanisms for intelligent systems where autonomy, adaptation, and feedback processes play a key role in artificial intelligence.

In particular, the NDF is new concept that can represent a data set of individual classes of a set of classes in non-linear distribution via machine learning. Competitive decisions are determined among the NDFs of each class. Additionally, the DNDF learns its own data set and does not need to know other data sets, which better emulates the biology of learning. Furthermore, self-adjusting neural gain is used for activation functions, which is used for proper learning from new classes (arriving later) via feedback results. Hence, the DNDF aspects discussed herein enable an autonomous learning system for cognitive capabilities to obtain self-learning goals.

The present disclosure also provides a DNDF architecture that handles data more effectively than existing ML techniques, and provides several advantages over existing ML techniques including, for example, the DNDF architecture is faster at learning and uses a less a complex ML architecture than existing approaches since there is no competition between classes; the DNDF architecture allows for un-supervision and self-learning due to being equipped with a dynamic learning architecture; the DNDF architecture enables autonomous learning via a feedback mechanism by changing the neural gain; and the DNDF architecture can accommodate new classes in a way that emulates biological learning capabilities better than existing techniques, and therefore, the DNDF architecture does not need to restart the learning process (which is not the case with existing ML approaches).

One benefit of the DNDF approaches discussed herein is that it reduces the learning time due to not learning against other NDFs. For example, a DNDF architecture is capable of learning class A, class B, and class C separately and independently from one another, while traditional techniques such as backpropagation (backprop), learns in sequences (e.g., Class A, NOT Class B, NOT Class C), (NOT Class A, Class B, NOT Class C), and (NOT Class A, NOT Class B, Class C). In addition, backprop learning competition among classes requires substantial time to iterate them to settle down. DNDF reduces n times of learning time with n classes. In this way, DNDF uses less computational resources and less computational time than existing machine learning approaches. DNDF also has no conversion problem where the challenges for learning like backprop are often faced. Another benefit of the DNDF approaches discussed herein is that there is no architecture crisis where it is started with a simple perceptron and then more neurons are added until the goal is met. By contrast, backprop techniques require a predetermined architecture, which can be done with simple data set and an experienced user. If no conversion, the system is dismantled and starts all over again. DNDF also provides autonomy which incorporates the feedback loop to adjust the neuron gain to meet the learning goals. This enables autonomous learning with a high level of confidence and/or provides robust learning.

### 1.1. Learning Approaches

### 1.1.1. Cascade Error Projection Learning

In various implementations, the DNDF uses a Cascade Error Projection (CEP) neural network (NN) learning algorithm (see e.g., Tuan A. Duong, Cascade Error Projection—An Efficient Hardware Learning Algorithm, PROCEEDINGS OF INT'L CONFERENCE ON NEURAL NETWORKS (ICNN'95), vol. 1, pp. 175-178 (27 Oct. 1995), Duong et al., Cascade Error Projection Learning Algorithm, NASA JET PROPULSION LABORATORY (JPL), JPL clearance no. 95-0760 (May 1995), http://hdl.handle.net/2014/30893, Tuan A. Duong, Convergence Analysis of Cascade Error Projection—An Efficient Learning Algorithm for Hardware Implementation, INT'L J. OF NEURAL SYSTEMS, vol. 10, no. 03, pp. 199-210 (June 2000), Tuan A. Duong, Cascade Error Projection Learning Theory, NASA JET PROPULSION LABORATORY (JPL), JPL clearance no. 95-0749 (May 1995), and Duong et al., Shape and Color Features for Object Recognition Search, HANDBOOK OF PATTERN RECOGNITION AND COMPUTER VISION, Chap. 1.5, Ed. C. H. Chen, 4th Edition by World Scientific Publishing Co. Pte. Ltd., (January 2010), the contents of each of which are hereby incorporated by reference in their entireties). The CEP algorithm was developed by the PI for NASA-specific missions. The CEP NN algorithm has been shown to be successful for applications, such as quality food detection, landing site identification, and life detection (see e.g., Fiesler et al., Color Sensor and Neural Processor on One Chip, Proc. SPIE 3455, APPLICATIONS AND SCIENCE OF NEURAL NETWORKS, FUZZY SYSTEMS, AND EVOLUTIONARY COMPUTATION, pp. 214-221 (13 Oct. 1998); https://doi.org/10.1117/12.326715, Tuan A. Duong, Real Time Adaptive Color Segmentation for Mars Landing Site Identification, J. OF ADVANCED COMPUTATIONAL INTELLIGENCE AND INTELLIGENT INFORMATICS, Japan, vol. 7, no. 3, 200, pp. 289-293, Duong et al., Neural Network Learning for Reduced Ion Mobility of Amino Acid Based on Molecular Structure, 37TH ANNUAL LUNAR AND PLANETARY SCIENCE CONFERENCE, p. 1474-1475 (March 2006); WCCI'06, Canada, pp. 1078-1084 (1-21 Jul. 2006).

FIG. 1 depicts an example CEP NN architecture 100 that includes a set of inputs 101 (e.g., including X₁ to Xₙ belonging to an input pattern X^{p}), a set of learned frozen weights 102 (also referred to as “learned frozen weight set 105” or the like), a previous hidden unit 110, a learned weight block 115, a current hidden unit 120, a set of calculated frozen weights 125 (also referred to as “calculated frozen weight set 125” or the like), a set of calculated weights 130, a set of neuron activation functions 133-1 to 133-m (where m is a number), and a set of output units 135. In the following discussion, the set of learned frozen weights 102 is denoted as Wᵢₕ₍ₙ₎, the learned weight block 115 is denoted as Wᵢₕ₍ₙ₊₁₎, the set of calculated frozen weights 125 is denoted as Wᵢₙ or Wᵢₒ, the set of calculated weights 130 is denoted as Wₕₒ₍ₙ₊₁₎ or Wₕₒ₍ₙ₊₁₎, and the set of output units 135 is denoted as (Oₗ^{p}, . . . , Oₘ^{p}) or Oᵢ. In FIG. 1, the shaded circles are a learned weights that is/are frozen (Wᵢₕ₍ₙ₎), the unshaded (open) circles are learned weights (Wᵢₕ₍ₙ₊₁₎), the shaded squares are calculated weights that are computed and frozen (Wᵢₙ), and the unshaded (open) squares are calculated weights (Wₕₒ₍ₙ₊₁₎). In particular, the circles indicate that learning is applied to obtain the weight set using perceptron learning, and squares indicate that the weight set is deterministically calculated Additionally, the unshaded (open) circles and squares are weight components that determine the weight values by learning or calculation.

In certain embodiments, the weights Wᵢₕ₍ₙ₎ are learned from a frozen NN and/or the weights Wᵢₕ₍ₙ₎ are frozen during a training process. Here, the weights Wᵢₕ₍ₙ₎ are learned from previous frozen hidden units and it inputs, and then the weights Wᵢₕ₍ₙ₎ are frozen at the end of that training process. A frozen NN is one in which only portion of the NN's parameters are trained and the remaining parameters are frozen at their initial (pre-trained) values, leading to faster convergence and a reduction in the resources consumed during the training process. By freezing the weights, the number of trainable parameters is shrunken which reduces gradient computations and the dimensionality of the model's optimization space. As examples, weight set Wᵢₕ₍ₙ₎ can be frozen and/or learned according to any suitable freezing technique, such as any of those discussed in Wimmer et al., Dimensionality Reduced Training by Pruning and Freezing Parts of a Deep Neural Network, a Survey, arXiv: 2205.08099v1 [cs.LG] (17 May 2022), the contents of which is hereby incorporated by reference in its entirety.

The CEP NN architecture 100 includes two sub-networks, including a first sub-network that uses perception (perceptron) learning (e.g., a primary network) and a second sub-network that uses deterministic calculations (e.g., a secondary network). In this example, the first sub-network corresponds to the calculated frozen weight set 125, and the second sub-network corresponds to the current hidden unit 120. The architecture 100 starts out as a single layer perception and adds hidden units when needed, one after another. The network contains n hidden units and the learning cannot be improved any further in the energy level. At this point, a new hidden unit (e.g., n+1) is added to the network. Additionally, N is the dimension of the input space, n+1 is the dimension of the expanded input space (e.g., n+1 is dynamically changed and is based on the learning requirement), m is the dimension of the output space, P is the number of training patterns, and f is a sigmoidal transfer function which is defined by equation (5). Additionally or alternatively, each of the neuron activation functions 133-1 to 133-m (collectively referred to as “neuron activation functions 133” or “neuron activation function 133”) may be logistic and/or sigmoidal activation functions (e.g., which may be the same or similar as the sigmoidal transfer function f), or some other type of activation function, such as any of those discussed herein). Additionally or alternatively, the neuron activation functions 133 may have the same or similar activation functions as the hidden units. Other notions are summarized in Table 1, infra.

An energy function for the CEP NN architecture 100 is defined by equation (1), and equation (2) denotes the error for output index o and training pattern p between target t and the actual output o(n), wherein n indicates the output with n hidden units in the network.

$$E ( n + 1 ) = {\sum }_{p = 1}^{P} {\{ {f}_{h}^{P} ( n + 1 ) - \frac{1}{m} {\sum }_{o = 1}^{m} ( {t}_{o}^{P} - {O}_{o}^{P} ) \}}^{2} \qquad ( 1 )$$

$${ε}_{o}^{P} = {t}_{o}^{P} - {O}_{o}^{P} ( n ) \qquad ( 2 )$$

The weight update between the inputs (including previously added or expanded hidden units) and the newly added hidden unit is calculated as shown by equation (3).

$$Δ {w}_{ih}^{P} ( n + 1 ) = - η \frac{\partial E ( n + 1 )}{\partial {w}_{ih}^{P} ( n + 1 )} \qquad ( 3 )$$

Additionally, the weight updates between hidden unit n+1 (or hidden unit h) and the output unit o is shown by equation (4) with the sigmoidal transfer function which is defined by equation (5).

$${w}_{ho} ( n + 1 ) = \frac{{\sum }_{p = 1}^{P} {ε}_{o}^{P} {f}_{o}^{′ p} {f}_{h}^{p} ( n + 1 )}{{{\sum }_{p = 1}^{P} [ {f}_{o}^{′ p} {f}_{h}^{p} ( n + 1 ) ]}^{2}} \qquad ( 4 )$$

$$f ( x ) = \frac{1 - {e}^{- x}}{1 + {e}^{- x}} \qquad ( 5 )$$

Notations used in equations (1), (2), (3), (4), (5), (6), (7), (8) are summarized by Table 1.

TABLE 1

| Parameter | Description |
|---|---|
| E | energy function |
| ${ε}_{o}^{P}$ | Error output index o and training pattern p between target t and the |
| | actual output o(n) (see equation (2), supra) |
| f | sigmoidal transfer function which is defined by equation (5), supra |
| ${f}_{h}^{P}$ | sigmoidal transfer function for training pattern p and hidden unit h |
| ${f}_{o}^{′ p} ( n ) = {f}_{o}^{′ p}$ | an output transfer function derivative with respect to its input index o and training pattern p |
| ${f}_{h}^{p} ( n + 1 )$ | a transfer function of hidden unit n + 1 for training pattern p |
| h | hidden unit |
| ih | denotes input hidden unit |
| m | the dimension of the output space and/or the number of outputs |
| n | the number of previously added hidden units |
| n + 1 | the dimension of the expanded input space |
| N | the dimension of the input space and/or the number of input units |
| η | a learning rate, which may be a predefined or configured value |
| α | neural gain (In certain embodiments, α = η) |
| o | output unit |
| o(n) | output unit with n hidden units in the network |
| ${O}_{o}^{P} ( n )$ | output element o of the actual output o(n) for training pattern p |
| p | a training pattern currently being processed (e.g., a “subject training |
| | pattern”) |
| P | the number of training patterns |
| t | a target (also referred to as “target element”) |
| ${t}_{o}^{P}$ | target element of output unit o for input training pattern p |
| $Δ {w}_{ih}^{P}$ | The weight update between inputs including previously added hidden units n and the newly added hidden unit n + 1 |
| Wᵢₙ | calculated weights that are frozen |
| Wᵢₕ₍ₙ₎ | learned weights that are frozen for hidden unit n |
| Wᵢₕ₍ₙ₊₁₎ | learned weights that are frozen for hidden unit n + 1 |
| Wₕₒ | calculated weights |
| Wₕₒ₍ₙ₊₁₎ | calculated weights at n + 1 |
| Xₙ | denotes the input of hidden unit n |
| X^{p} | denotes the input pattern p or a p-dimensional vector |

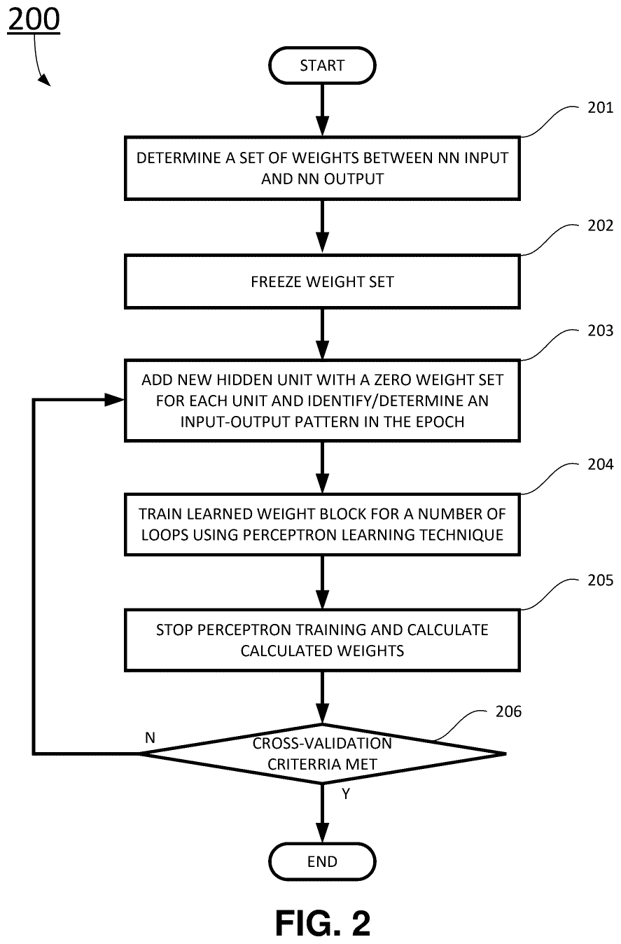

In some implementations, the CEP learning algorithm is processed in two steps wherein a first step includes single perceptron learning, and a second step includes obtaining the weight set Wₕₒ₍ₙ₊₁₎. The single perceptron learning is governed by equation (3) to update the weight vector Wᵢₕ₍ₙ₊₁₎ (step 1). When the single perceptron learning is completed, the weight set Wₕₒ₍ₙ₊₁₎ can be obtained by the calculation governed by equation (4) (step 2). An exemplary CEP learning procedure is shown by FIG. 2.

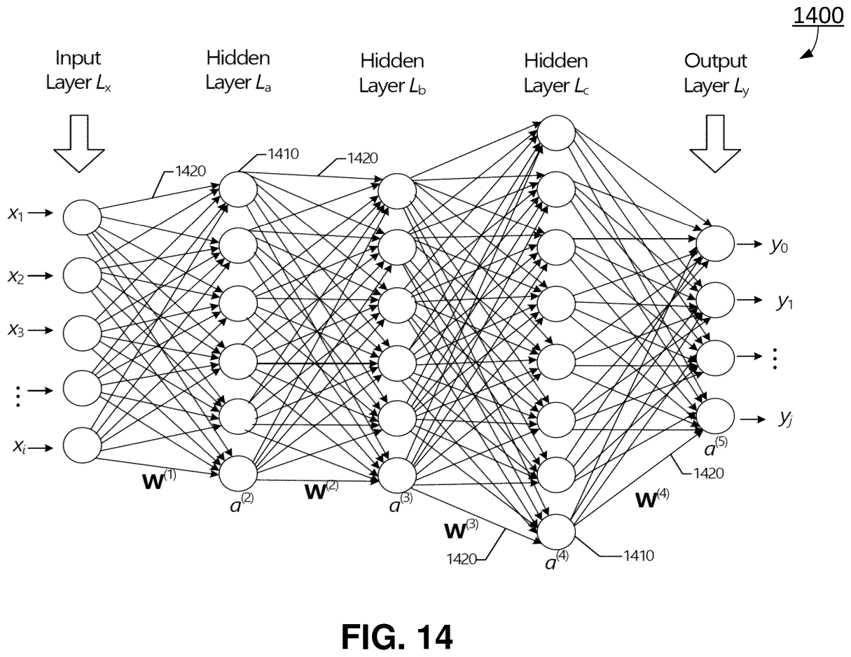

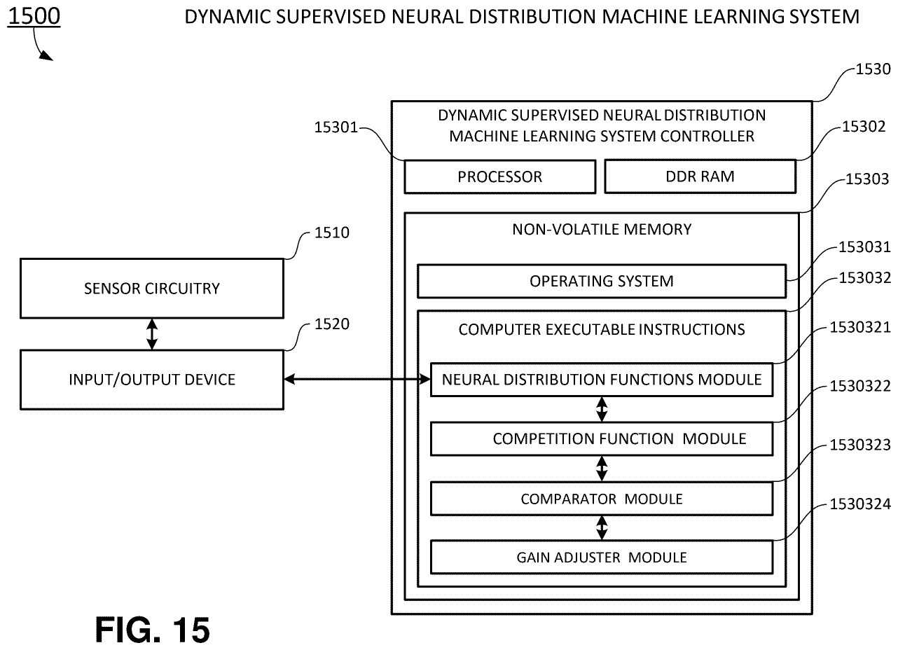

FIG. 2 shows an exemplary CEP learning procedure 200, which may be performed by a dynamic supervised neural distribution function machine learning system, as shown in FIG. 15. The CEP learning procedure 200 starts with a neural network, which has input and output neurons (see e.g., FIG. 14). With the given input and output patterns and hyperbolic transfer function, at operation 201, the dynamic supervised neural distribution function machine learning system 1500 determines a set of weights (e.g., weight set Wᵢₒ) between the input and output using, for example, pseudo-inverse learning and/or perceptron learning. At operation 202, the dynamic supervised neural distribution function machine learning system 1500 freezes the weight set Wᵢₒ. At operation 203, the dynamic supervised neural distribution function machine learning system 1500 adds a new hidden unit with a zero weight set for each unit. In each loop (contains an epoch) an input-output pattern is picked up randomly in the epoch (no pattern is repeated until every pattern in the epoch is pick). At operation 204, the dynamic supervised neural distribution function machine learning system 1500 uses a perceptron learning technique of equation (3) to train the weight set Wᵢₕ₍ₙ₊₁₎ for a predetermined or configured number of loops (e.g., 100 loops). At operation 205, the dynamic supervised neural distribution function machine learning system 1500 stops the perception training and calculate the weight(s) Wₕₒ₍ₙ₊₁₎ between the current hidden unit n and the output units from equation (4). At operation 206, the dynamic supervised neural distribution function machine learning system 1500 performs a cross-validation of the network, and determines if the criteria is satisfied. If so, the procedure 200 ends. Otherwise, the dynamic supervised neural distribution function machine learning system 1500 proceeds back to operation 203. In some examples, the dynamic supervised neural distribution function machine learning system 1500 loops back to operation 203 until the number of hidden units is more than a predefined or configured amount (e.g., 20) and then terminations the procedure 200.

Referring back to FIG. 1, the number of computations for a complete learning DNDF can be formulated as shown by equation (6).

$$NP = {N}_{p} [ ( n + {n}_{o} ) {n}_{i} + \frac{n ( n - 1 )}{2} + 6 {n}_{o} + ( n - 1 ) {n}_{o} ] {N}_{iter} \qquad ( 6 )$$

In equation (6), NP is the number of computations (e.g., iterations, epochs, or the like) that should be performed for complete DNDF learning, Nᵢₜₑᵣ is a number of learning iteration, Nₚ is a number of training patterns, n is a number of hidden units, nᵢ is a number of input units, and nₒ is a number of output units. Additionally, the computations (e.g., multiplication and addition) can be approximated as shown by equation (7), where O(⋅) refers to the “order of” or a measure of complexity in Big O notation, which is a mathematical notation that describes the limiting behavior of a function or algorithm when the argument tends towards a particular value or infinity. The Big O notation is often used to classify algorithms according to how their running time or space requirements grow in size as the input size grows. It should be noted that the specific time and/or size complexity of a specific implementation may vary based on the memory structures used when operating the algorithms.

O(Nₚ(n+nₒ)nᵢNᵢₜₑᵣ) (7)

### 1.1.2. Neural Distribution Function Aspects

An NDF is a distribution of predictions or inferences produced by a learning algorithm (e.g., the CEP learning algorithm discussed previously and/or any other suitable NN/learning algorithm, such as any of those discussed herein). In certain embodiments, an NDF can be viewed as similar to the concept of a Gaussian distribution and/or a probability density function in that each NDF can include a continuous probability distribution for predictions generated using a learning algorithm (e.g., CEP learning and/or some other ML algorithm/model, such as any of those discussed herein). In certain embodiments, each NDF is an individual NN, which may be arranged or configured in any suitable NN topology and/or using any suitable ML technique, such as any of the NNs/ML techniques discussed herein. In some implementations, an NDF can be expressed as shown by equation (8), where ψₖ is defined as an NDF of class k and is synthesized via CEP learning to obtain \hat{N}, where \hat{N} is a function of wₖ sets, wₖ is a set of weights for class k, nₖ is a number of hidden units of class k in the cascading architecture (e.g., CEP NN architecture 100 of FIG. 1), αₖ is a neural gain (e.g., learning rate or adaptive control factor), and X is an input vector/tensor (which may be the same or similar as X^{p} discussed previously). In certain embodiments, the ψᵢ is the same as the output unit Oᵢ from FIG. 1 (e.g., output unit 135). In certain embodiments, the neural gain αₖ is the same as the learning rate parameter η of equation (3) (supra). Additionally, the NDFs ψₖ and ψⱼ are trained independently from one another, and have no correlation with each other and/or other distribution functions.

ψₖ=\hat{N}(wₖ,nₖ,αₖ,X) (8)

### 1.1.2.1. Neural Distribution Architecture

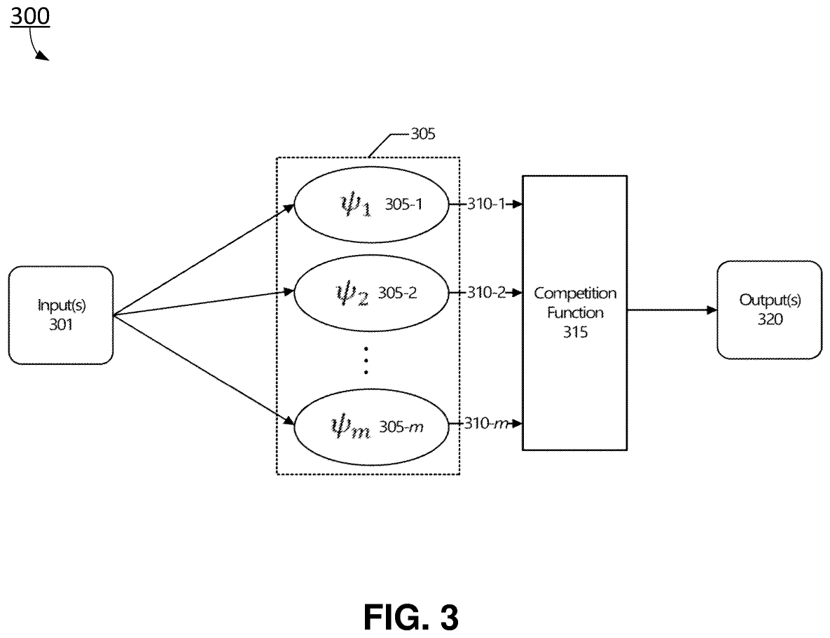

FIG. 3 depicts an exemplary DNDF architecture 300. The DNDF architecture 300 includes independent NDFs 305-1 to 305-m (collectively referred to as “NDFs 305” or “NDF 305”) and a competition function 315 that is used to determine a winning output 310 as a classifier. In the DNDF architecture 300, each NDF 305 includes its own NDF ψₖ (where k is a number between 1 and m) that is learned using its own class data, independently and sequentially (see e.g., equation (8)), and the data is not constrained by the number of samples (e.g., can be a few samples, or a single sample). For example, each NDF 305 may be learnt using the CEP learning procedure 200 and/or CEP NN architecture 100 discussed previously. Additionally or alternatively, each NDF 305 is an individual NN (see e.g., NN 1400 of FIG. 14), which may be arranged or configured in any suitable NN topology and/or using any suitable ML technique, such as any of the NNs/ML techniques discussed herein. Furthermore, some NDFs 305 may have different configurations, arrangements, and/or topologies than one or more other NDFs 305. For example, NDF 305-1 can have a first ML arrangement/topology, NDF 305-2 can have a second ML arrangement/topology, and NDF 305-m can have a m-th ML arrangement/topology, where the first ML arrangement/topology may be the same or different than the second ML arrangement/topology and/or the m-th ML arrangement/topology. Additionally or alternatively, each NDF 305 may have the same or different activation functions, and any suitable activation function can be used for an individual NDF 305, such as any of those discussed herein. Additionally or alternatively, each NDF 305 is a respective sub-network (or “subnet”) of a super-network (or “supernet”), wherein the super-network comprises the set of NDFs 305. Here, the supernet may be a relatively large and/or dense ML model that contains a set of smaller subnets, and each of the subnets may be training individually and/or in isolation from on another (and independent of training the supernet as a whole). Additionally or alternatively, the set of NDFs 305 can be arranged in a suitable ML pipeline and/or ensemble learning arrangement.

The NDFs 305 produce respective outputs 310-1 to 310-m (collectively referred to as “outputs 310” or “output 310”), which are provided to a competition function 315. In certain embodiments, each output 310 may be, or include, a DB derived and established from its corresponding NDF 305 and/or a set of classification datasets assigned to different sides of the DB. In certain embodiments, the output 310 is learned using the same learning algorithm used to generate or create the corresponding NDF 305. In certain embodiments, the DB is learned using a passive learning mechanisms/technique. In any of the implementations discussed herein, the format/structure of each output 310 may be a single value, a vector or tensor in the range of [0-1], or some other suitable data structure. In some implementations, the outputs 310 are candidates (e.g., candidate DBs and/or classifications), and the competition function 315 performs a predefined, configured, or learned competition to select a “winning” candidate output 310 among the set of outputs 310-1 to 310-m, and then generates the output 320 to include the “winning” candidate output 310. As examples, the competition function 315 can be implemented or otherwise embodied as a maximum (max) function, minimum (min) function, folding (fold) function, radial function, ridge function, softmax function, maxout function, argument of the maximum (arg max) function, argument of the minimum (arg min) function, ramp function, identity function, step function, Gaussian function, a logistic function, a sigmoid function, a transfer function, and/or any other suitable function or algorithm, such as any of those discussed herein or any combination thereof. Additionally or alternatively, the competition function 315 is implemented or otherwise embodied as an ML model that is trained to select “winning” candidates 310 based on learnt parameters, configurations, conditions, and/or other criteria. In certain embodiments, the competition ML model 315 can be implemented as a reinforcement learning (RL) model and/or any other ML model/algorithm, such as any of those discussed herein. Additionally or alternatively, the competition ML model 315 can be trained to select a “winning” candidate 310 based on, for example, ML configuration data (e.g., model parameters, hyperparameters, parameters/configuration of a hardware (HW) platform running the architecture 300, and the like), various measurements/metrics of ML model/algorithm performance (e.g., such as any of those discussed herein and/or as discussed in [Naser] and/or [Naser2]), measurements/metrics of the HW platform on which the ML model/algorithm is running and/or is designed to run on (e.g., such as any of those discussed herein and/or as discussed in [VTune]), and/or any other parameters, conditions, and/or criteria, such as any of those discussed herein.

To validate its performance, a test vector (e.g., an input vector X as described previously) is served as an input 301 to each NDF 305, and each NDF 305 produces or otherwise generates a corresponding (candidate) output 310 that is provided to the competition function 315. The outputs 310 are compared through the competition function 315 to obtain an index of a “winning” output (candidate) 310 to determine a class that the winner's index belongs to. Here, the output 320 is an index or other reference pointing to the “winning” one of the outputs 310, and the “winner” (or “winning class”) is an output 310 having a highest or maximum value among the set of outputs 310-1 to outputs 310-m. For example, where the competition function 315 is a max function, the competition function 315 compares the outputs 310 and obtains an index of the maximum output 310 to determine what class it belongs to. In certain embodiments, the DNDF architecture 300 is used to test exclusive OR (XOR) and additive class learning (ACL) where data is nonlinear, but not ambiguous, as is discussed infra.

1.1.2.2. Neural Distribution Architecture with Feedback Mechanism

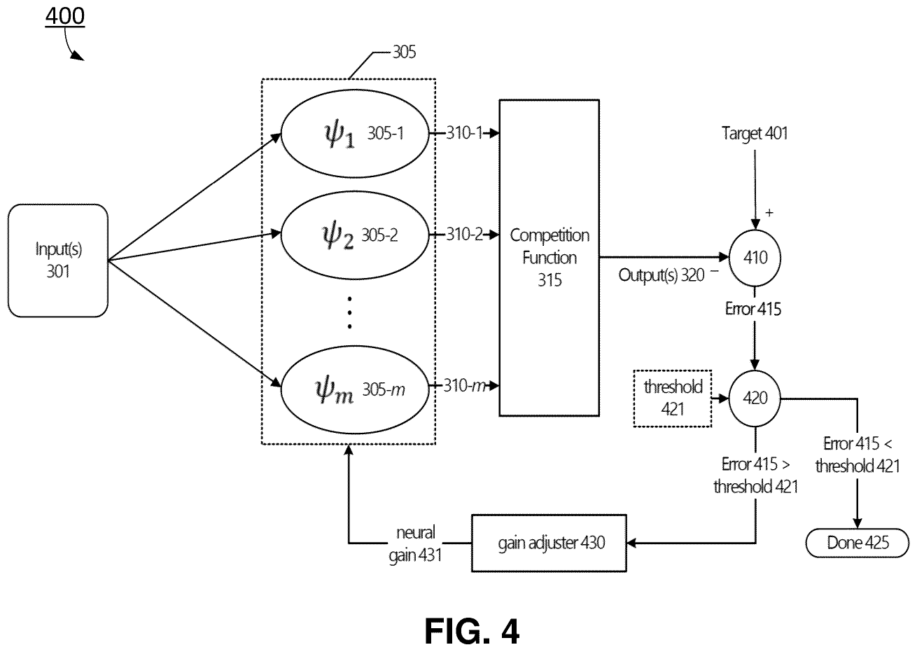

FIG. 4 depicts an exemplary feedback DNDF architecture 400. The DNDF architecture 400 includes the DNDF architecture 300 with a feedback mechanism for enabling learning autonomy. Here, the output(s) 320 of the competition function 315 are provided to a comparison function (comparator) 410, which compares the output(s) 320 with a target 401 configuration or parameter set. The target 401 is a given new class of m. In certain embodiments, the target 401 is the same as the target t and/or in

$${t}_{o}^{P}$$

in Table 1. The comparator 410 produces an error value 415 (e.g., root mean square (RMS) error or some other quantification of error) based on the comparison of the output(s) 320 with the target 401. In one embodiment, the comparison performed by the comparator 410 may be expressed as shown by equation (2) (supra). Additionally or alternatively, the comparison performed by the comparator 410 may be expressed as shown by equation (9), where ε is the error value 415, comp(.) is the competition function 315, t is the target 401, D is the winning NDF 305, selected output 315 and/or output 320, and j=1:k.

ε=t-comp(D(j)) (9)

In an example where the competition function 315 is a max function, the comp(.) in equation (9) may be replaced with max(.). The error value 415 is then provided to a comparator 420. The comparator 420 compares the error 415 with a predefined or configured error threshold 421. In certain embodiments, the comparator 420 comprises one of the comparison mechanisms/functions discussed previously w.r.t comparator 410, or may include any of the competition mechanisms/functions discussed herein. Additionally or alternatively, the comparator 420 may be the same or similar as the comparator 410 or otherwise operates in a same or similar manner as the comparator 410. If the error 415 is less than the threshold 421, the learning is completed 425. If the error 415 is more than the threshold 421, a neuron/neural gain adjuster 430 adjusts a neural gain 431 (e.g., αₖ), which is then fed back to each of the NDFs 305.

The neural gain 431 output by the gain adjuster 430 may include the actual, updated/adjusted neural gains α to be used by corresponding NDFs 305, or the neural gain 431 output by the gain adjuster 430 may include respective update/adjustment factors and/or respective gain update/adjustment types that is/are to be used by the corresponding NDFs 305 to adjust their own neuron gain α, accordingly. Additionally, in some implementations, the neural gain α of each NDF 305 is independent of the neural gain α of other NDFs 305. For example, a neural gain α-1 of NDF 305-1 is independent of a neural gain α-2 of NDF 305-2, such that neural gain α-1 may or may not be equal to neural gain α-2. In these implementations, the gain adjuster 430 may change different neural gains a differently for one or more of the NDF 305. For example, the neural gain α-1 of NDF 305-1 may be changed by a first amount, the neural gain α-2 of NDF 305-2 may be changed by a second amount, and the first amount may be greater than, less than, or equal to the second amount. The specific values, types, and/or adjustment/update factors of each neural gain α may be implementation-specific, based on use case and/or design choice (e.g., ML parameter selection), and may vary from embodiment to embodiment. In certain embodiments, if the learning still contains more than the threshold amount 421 of errors 415, the neural gain 431 is reduced by the neuron/neural gain adjuster 430 iteratively until the learning process is completed (e.g., after a predefined or configured number of epochs/iterations, when the ML model 400 converges to a predefined, configured, or learned value, and/or based on some other conditions or criteria). In certain embodiments, the feedback mechanism (e.g., 410, 420, 430) is only used for current new classes to ensure the training is completely correct. In these ways, the feedback mechanism of FIG. 4 enables the autonomy of the learning system. Additionally or alternatively, the DNDF architecture 400 may be useful for use cases where data becomes ambiguous and/or when unmanned learning operation is desired. In one exemplary implementation, the NDFs 305 are subnets or components of an object recognition model (e.g., a supernet), and the DNDF architecture 400 is used to train the object recognition model. In an example, the object recognition model, when trained, is configured to perform object recognition in image and/or video data by emulating retina, fovea, and lateral geniculate nucleus (LGN) of a vertebrate based on simulated/emulated saccadic eye movements.

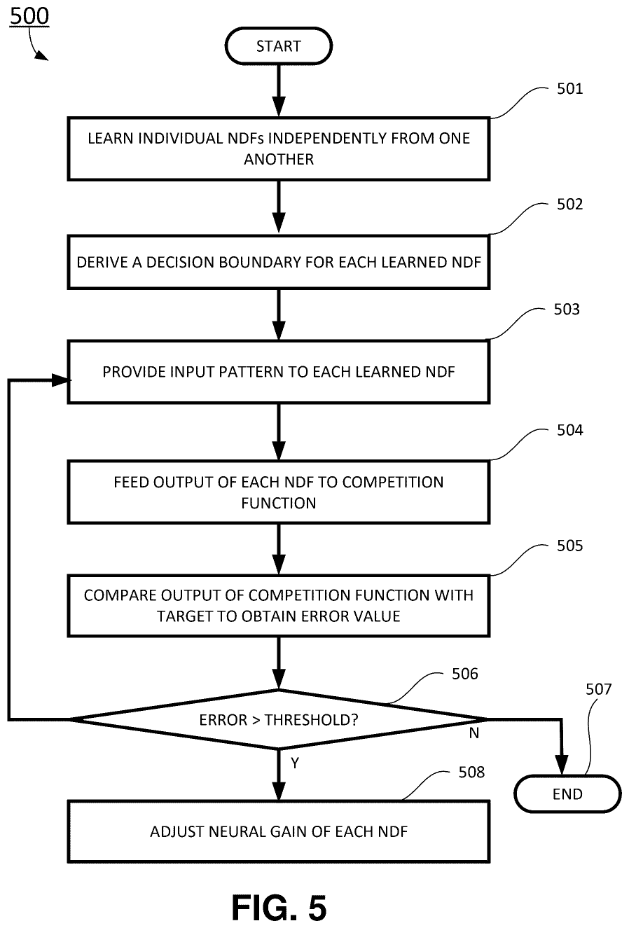

FIG. 5 depicts an exemplary DNDF process 500, which may be performed by a DNDF (e.g., DNDF architecture 300 and/or 400 discussed previously), or by a dynamic supervised neural distribution function machine learning system on which the DNDF operates as shown in FIG. 15. The DNDF process 500 begins at operation 501 where the DNDF learns individual NDFs 305 independently from one another. For example, the individual NDFs 305 may be learned using the CEP learning procedure 200 and/or some other learning algorithm.

At operation 502, the DNDF derives or otherwise determines a DB for each learned NDF 305 independently from one another. In certain embodiments, the DB of each class (or each NDF 305) is learned using the same learning algorithm as used in operation 501 (e.g., the CEP learning procedure 200 and/or the like). Additionally or alternatively, the DB of each class can be derived using the same competition mechanism/function of the competition function 315, or a different one or more of the competition mechanisms/functions discussed previously with respect to competition function 315.

At operation 503, the DNDF provides an input pattern X^{p} (e.g., including a set of inputs X₁ to Xₙ) to each NDF 305. In certain embodiments, the input pattern X^{p} may be in the form of a feature vector or tensor comprising a set of data points to be classified or otherwise manipulated by each NDF 305. Each NDF 305 produces a respective output 310 based on the input pattern X^{p}, which is then fed to a competition function 315 at operation 504. In certain embodiments, the output 310 produced by each NDF 305 is a new or updated DB for the NDF 305. Additionally or alternatively, each NDF's 305 output 310 can include classified data sets falling on different sides of the NDF's 305 DB. In certain embodiments, an NDF's 305 DB is only counted when it is a winner of the competition function 315. At operation 505, the DNDF compares (e.g., comparator 410 of FIG. 4) the output 320 of the competition function 315 with a target 401 to obtain an error value 415. At operation 506, the DNDF determines whether the error value 415 is greater than a predefined or configured threshold 420 (e.g., comparator 420 of FIG. 4). If at operation 506 the error value 415 is not greater than the threshold 420, then the DNDF ends and/or outputs a result of the learning process at operation 507. If at operation 506 the error value 415 is not greater than the predefined/configured threshold, then the DNDF proceeds to operation 508 to adjust the neural gain 431 (e.g., learning rate) of each NDF 305, and then proceeds back to operation 503 to provide a next input pattern to each NDF 305.

### 1.1.2.3. Exclusive OR (XOR) Problem

The exclusive OR (XOR) problem is a classic problem in artificial NN research that involves training an NN to predict the outputs of an XOR logical function given two binary inputs. The XOR problem is a classical nonlinear benchmark problem where two classes are diagonal to require a nonlinear approach. A XOR function returns a value of true (or “1”) if two inputs to the XOR function are not equal, and returns a value of false (or “0”) if the two inputs to the XOR function are equal. However, the outputs of a XOR function are not linearly separable, which is a desirable capability for many NNs (including perceptrons) to have.

In this context, linear separability refers to the ability of an NN (e.g., an individual NDF 305) to classify data points to fall on one side of a DB on another side of the DB. In other words, linear separability of data points is the ability for an NN to classify data points in a hyperplane by avoiding the overlapping of classes in the planes such that data points belonging to individual classes should fall on one side of the DB or the other. The outputs generated by a XOR function are not linearly separable because the output data points will overlap with a linear DB line and/or different classes occur on a single side of the linear DB. Therefore, the XOR problem was used to test and/or ensure the non-linear separability of the DNDF architectures 300, 400. The data and computation requirements for the XOR problem are shown in Table 2, and its performance parameters are shown in Table 3.

TABLE 2
Sample data for XOR problem

| | | | | | | | | | |
|---|---|---|---|---|---|---|---|---|---|
| Class Red (−1) | 1.0 | 0.8 | 1.1 | 1.2 | 1.1 | 0.8 | 0.9 | 1.2 | 0.9 |
| X | 1.0 | 1.2 | 0.9 | 0.8 | 1.1 | 0.8 | 0.9 | 1.2 | 1.1 |
| Y | −1.0 | −1.2 | −0.8 | −0.8 | −0.9 | −1.1 | −1.1 | −0.9 | −1.2 |
| | −1.0 | −0.8 | −1.2 | −0.8 | −1.1 | −0.9 | −1.1 | −0.9 | −1.2 |
| Class Blue (1) | 1.0 | 1.1 | 1.1 | 0.9 | 0.8 | 1.2 | 0.8 | 0.9 | 1.2 |
| X | −1.0 | −0.9 | −1.1 | −1.1 | −1.2 | −0.8 | −0.8 | −0.9 | −1.2 |
| Y | −1.0 | −1.1 | −1.1 | −0.9 | −0.9 | −0.8 | −1.2 | −0.8 | −1.2 |
| | 1.0 | 0.9 | 1.1 | 0.9 | 1.1 | 1.2 | 0.8 | 0.8 | 1.2 |

TABLE 3
Performance Parameters for XOR problem with RMS error = 0.001

| | | | Neuron | Number of | Number of |
|---|---|---|---|---|---|
| | Correct | RMS | Gain | Hidden | Compu- |
| | Learning | Error | (α) | Units | tations |
| Class Red (1) | 100% | 0.000908 | 1.4 | 3 | 14400 |
| Class Blue (−1) | 100% | 0.000907 | 1.4 | 3 | 14400 |
| XOR learning | 100% | | | | 28800 |

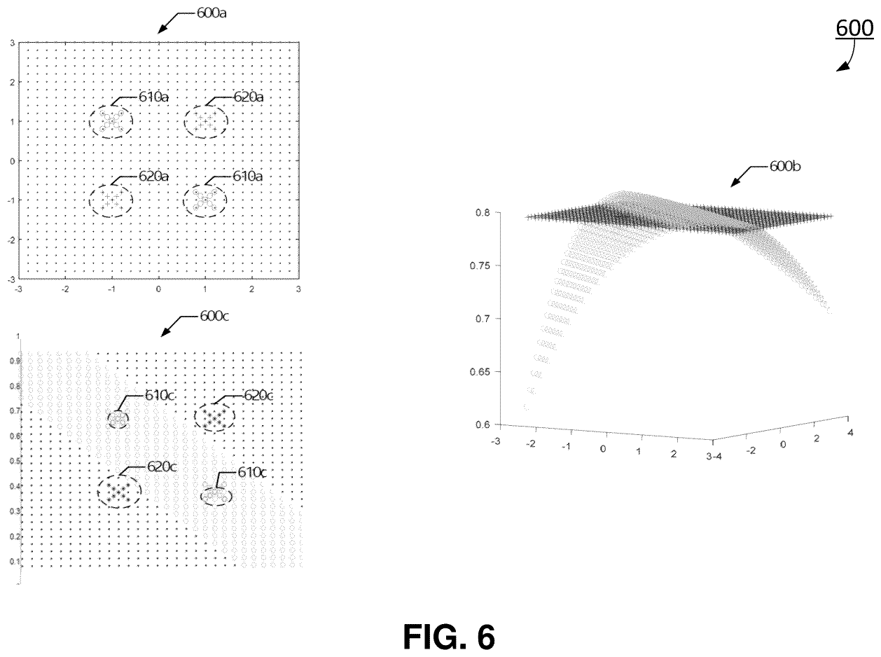

FIG. 6 shows a data set 600a (including red class data points 610a and blue class data points 620a), a neural distribution 600b, and a corresponding classification results 600c (including red class data points 610c and blue class data points 620c). Based on the data set 600a, the neural distribution 600b has established on its own via CEP learning and has no knowledge of its counterparts, and the learning results in graph 600c are checked by a program to ensure their accuracy. Graph 600c shows the non-linear separability of the XOR outputs produced by the DNDF architectures 300, 400.

### 1.1.2.4. Additive Class Learning (ACL) Asynchronously

Additive class learning (ACL) was performed to demonstrate that the DNDF architectures 300, 400 can sequentially learn one class after another without any interference from the previous knowledge. This is resembling to our brain learning thing: non-competitive one with others in visual sense. The data and computation requirements are shown by Table 4 and Table 5.

TABLE 4
Sample data for ACL problem

| | | | | | | | | | |
|---|---|---|---|---|---|---|---|---|---|
| Class Red (X, Y) | 1.0 | 1.1 | 1.1 | 0.9 | 0.9 | 0.8 | 1.2 | 1.2 | 0.8 |
| in step 1 | 1.0 | 0.9 | 1.1 | 0.9 | 1.1 | 1.2 | 0.8 | 1.2 | 0.8 |
| Class Green (X, Y) | −1.0 | −1.1 | −1.1 | −0.9 | −0.9 | −0.8 | −1.2 | −0.8 | −1.2 |
| in step 1 | −1.0 | −0.9 | −1.1 | −0.9 | −1.1 | −1.2 | −0.8 | −0.8 | −1.2 |
| Class Blue (X, Y) | −1.0 | −1.1 | −1.1 | −0.9 | −0.9 | −0.8 | −1.2 | −0.8 | −1.2 |
| in step 2 | 1.1 | 0.9 | 0.8 | 0.9 | 0.8 | 1.1 | 0.8 | 0.9 | 0.9 |
| Class Magenta (X, Y) | 1.0 | 1.1 | 1.1 | 0.9 | 0.9 | 0.8 | 1.2 | 0.8 | 1.2 |
| in step 3 | −1.0 | −0.9 | −1.1 | −0.9 | −1.1 | −1.2 | −0.8 | −0.8 | −1.2 |
| Class Back (X, Y) | 0.1 | −0.07 | −0.12 | −0.20 | −0.20 | 0.18 | 0.12− | 0.18 | 0.12 |
| in step 4 | −0.1 | 0.12 | 0.12 | −0.07 | −0.21 | −0.12 | 0.08 | −0.18 | 0.12 |
| Class Red - | 0.5 | 0.7 | 1.0 | 0.4 | | | | | |
| new Data updates | 1.0 | 0.7 | 0.5 | 0.4 | | | | | |

TABLE 5
Performance Parameters for ACL problem with RMS error = 0.1

| | Correct | | Neuron | Number of | Number of | |
|---|---|---|---|---|---|---|
| Class | Learning | RMS Error | Gain (α) | Hidden Units | Computations | Comments |
| Class Red | 100% | 0.046318 | 0.50 | 1 | 9000 | |
| Class Green | 100% | 0.046053 | 0.50 | 1 | 9000 | |
| Class Blue | 100% | 0.038563 | 0.50 | 1 | 9000 | |
| Class Magenta | 100% | 0.046138 | 0.50 | 1 | 9000 | |
| Class Yellow | 100% | 0.019144 | 1.35 | 2 | 42,300*15 | Adaptive gain |
| ACL Learning | 100% | | | | 634,500 | |

The ACL study starts with two classes, and sequentially adds additional classes into the network without any knowledge from each side. The steps of the ACL study discussed infra successfully demonstrate that the DNDF approaches discussed herein is able to learn one after another class in a similar manner as the human brain.

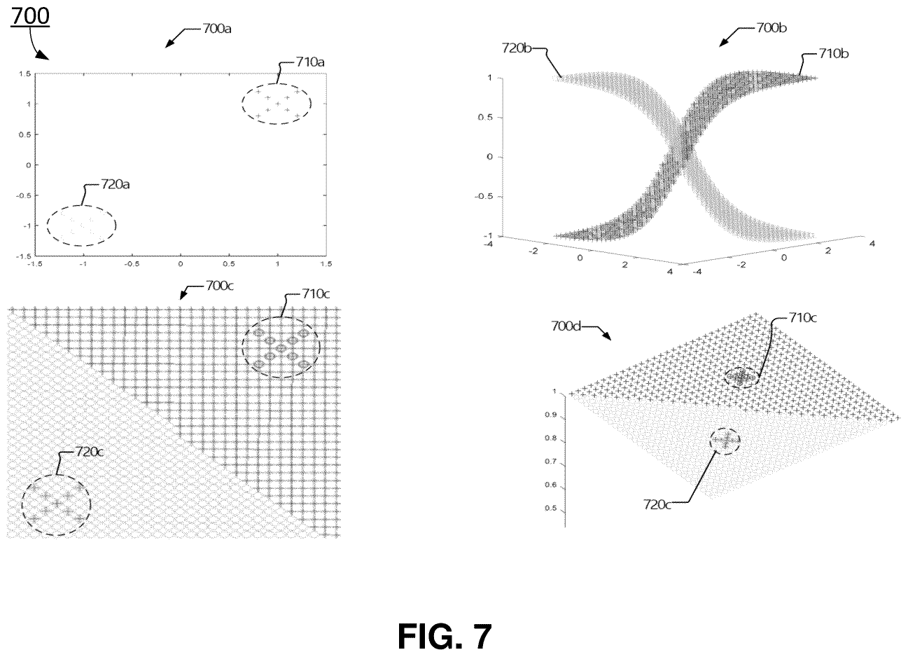

FIG. 7 shows step 1 of the ACL study, which involves learning two distributions. Here, two data sets are provided for a red class (e.g., red class data set 710a) and a green class (e.g., green class data set 720a), as shown in Table 4. This is also graphically shown by graph 700a in FIG. 7. After CEP learning, two DNDFs (e.g., NDFs 305) are obtained, including a red class DNDF 710b and a green class DNDF 720b as shown by graph 700b in FIG. 7 and the corresponding performance results have a learning accuracy being 100% correct as shown by graph 700c (including blue class data points 710c and magenta class data points 720c). Graph 700d shows another view of graph 700c. Graphs 700c and 700d show the linear separability of the outputs produced by the DNDF architectures 300, 400 for step 1 of the ACL study.

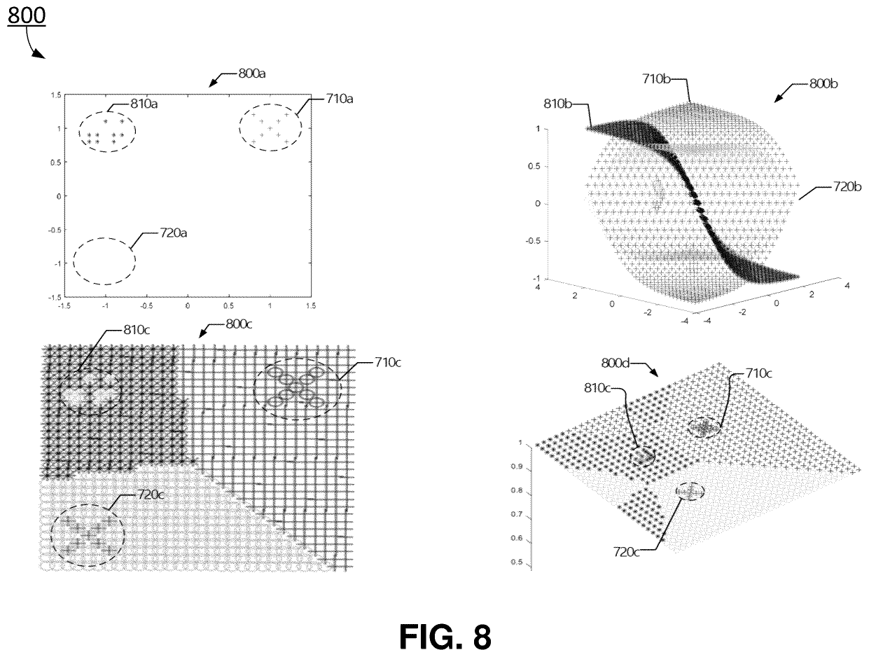

FIG. 8 shows step 2 of the ACL study, which involves adding a new class and learning its distribution. Here, a new blue class data set 810a is added to the network according to the data shown by the third row in Table 4, which is also shown by graph 800a in FIG. 8. The graph 800a includes the red class data set 710a, the green class data set 720a, and the newly added blue class data set 810a. Graph 800b shows DNDFs corresponding to the red, green, and blue classes, namely a blue class DNDF 810b that is shown along with the previous unchanged (frozen) red class DNDF 710b and green class DNDF 720b. The performance results are correct for all three classes via maximum value to define the identified class, as shown by graph 800c (including red class data points 710c, a green class data points 720c, and blue class data points 810c). Graph 800d shows another view of graph 800c. Graphs 800c and 800d show the non-linear separability of the outputs produced by the DNDF architectures 300, 400 for step 2 of the ACL study.

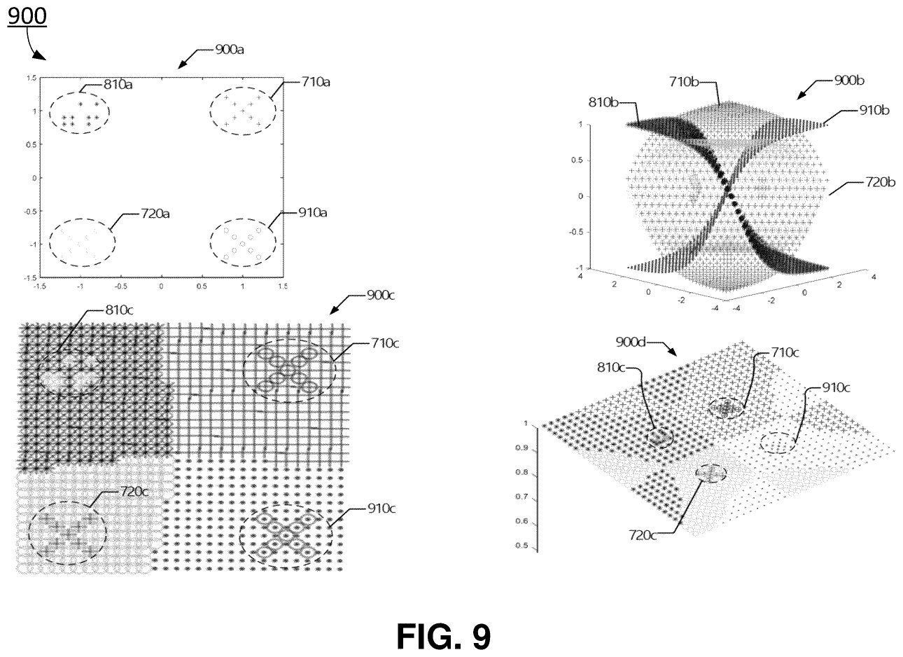

FIG. 9 shows step 3 of the ACL study, which involves adding another new class and learning its distribution. In the example of FIG. 9, data set 900a includes the red, green, and blue class data sets 710a, 720a, 810a discussed previously, as well as a newly added magenta class data set 910a. The magenta class data set 910a is the new class added into the network and is based on the data shown in fourth row of Table 4. A DNDF 910b of class magenta is shown by graph 900b along with the previous unchanged DNDF s 710b, 720b, 810b of the red, green, and blue classes. The performance results are correct for all four classes as shown by graph 900c (including red class data points 710c, a green class data points 720c, blue class data points 810c, and magenta class data points 910c). Graph 900c shows the non-linear separability of the outputs produced by the DNDF architectures 300, 400 for step 3 of the ACL study.

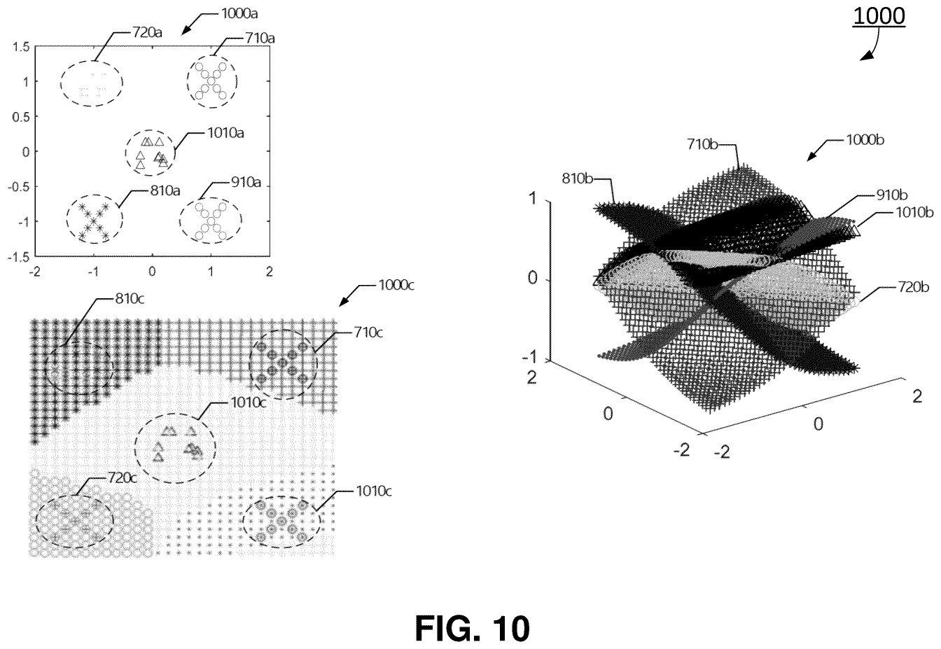

FIG. 10 shows step 4 of the ACL study, which involves adding another new class and learning its distribution. In this example, a new black class data set 1010a is added to the network along with the datasets 710a, 720a, 810a, 910a as shown by graph 1000a. The black class data set 1010a is based on the data shown in the fifth row of Table 4. A black class DNDF 1010b is shown by graph 900b along with the previous unchanged DNDFs 710b, 720b, 810b, 910b of the red, green, blue, and magenta classes. An output decision 1010c of the black class is shown by graph 1000c along with the outputs 710c, 720c, 810c, 910c of the previous red, green, blue, and magenta classes which are the closest learning target. The performance results are shown as being correct for all five classes as shown by graph 1000c. Graph 1000c shows the non-linear separability of the outputs produced by the DNDF architectures 300, 400 for step 4 of the ACL study.

### 1.1.3. Update Learning

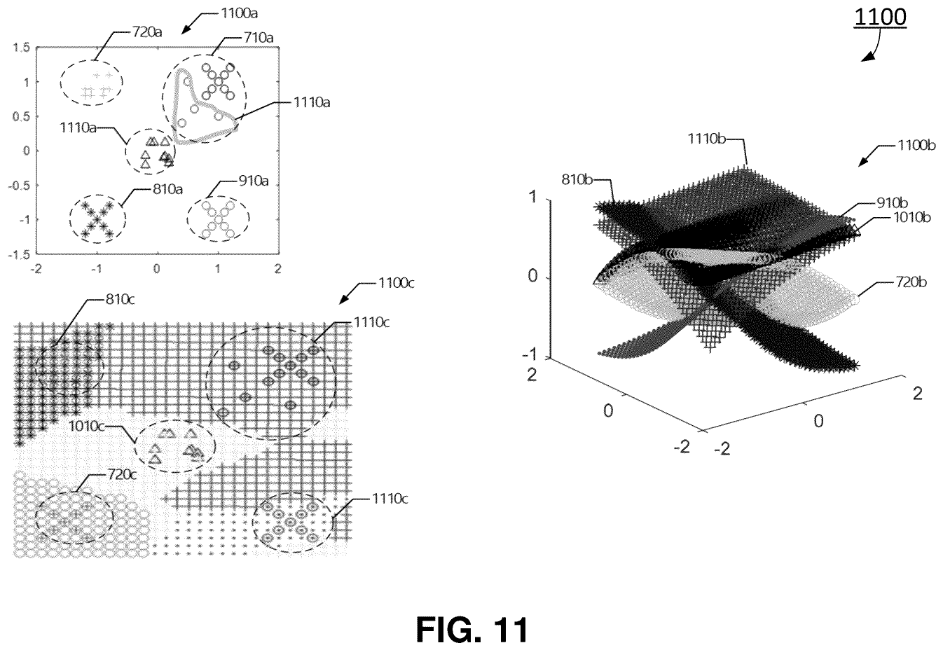

FIG. 11 shows an example of update learning, where a new dataset 1110a is added to the red class data set 710a as shown by graph 1100a. Update learning is performed where classes 720a, 810a, 910a are frozen. Graph 1100b shows a DNDF 1110b of the updated red class along with the DNDFs 710b, 720b, 810b, 910b, 1010b. Additionally, the output 1110c of DNDF 1110b is shown to be changed to meet the 100% training accuracy as shown by graph 1100c.

### 1.1.3.1. Non-Linear Sample Data (NSD)

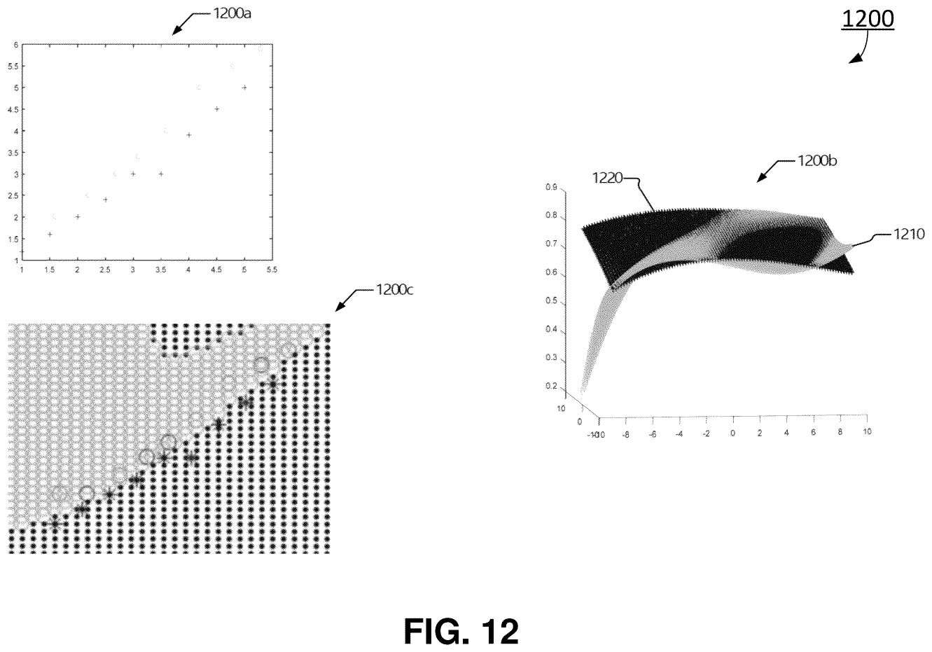

FIG. 12 shows aspects of a first non-linear sample data (NSD) study that was performed to show its superiority for autonomy over Support Vector Machine (SVM), which is well-established in a linear separable data set. A sample data set for the NSD problem is shown by Table 6. This data set may pose difficulties for SVM; however, it requires time for DNDF architecture to fine-tune the appropriate parameters. From this difficulty, a feedback network (see e.g., FIG. 4) is introduced to learn in a loop with the change of gain (e.g., neural gain αᵢ) from high to low until the learning performs 100% correct.

TABLE 6
Sample data for NSD problem

| | | | | | | | | | |
|---|---|---|---|---|---|---|---|---|---|
| Class Blue (X, Y) | 1.0 | 1.5 | 2.0 | 2.5 | 3.0 | 3.5 | 4.0 | 4.5 | 5.0 |
| | 1.2 | 1.6 | 2.2 | 2.4 | 3.0 | 3.0 | 3.9 | 4.6 | 5.0 |
| Class Green (X, Y) | 1.1 | 1.6 | 2.2 | 2.7 | 3.1 | 3.6 | 4.2 | 4.8 | 5.3 |
| | 2.0 | 2.0 | 2.5 | 3.0 | 3.4 | 4.0 | 5.0 | 5.5 | 5.9 |

The first NSD study involved iterating the gain starting from 0.5 with a step of 0.01, required 45 iterations of gain to reach to 0.065, and the total time for the feedback DNDF is 224100 computations.

TABLE 7
Performance Parameters for NSD problem with RMS error = 0.001

| | Correct | | Neuron | Number of | Number of | |
|---|---|---|---|---|---|---|
| | Learning | RMS Error | Gain (α) | Hidden Units | Computations | Comments |
| Class Red | 100% | 0.000989 | 0.0650 | 12 | 98100 | * |
| Class Green | 100% | 0.000941 | 0.0650 | 14 | 126000 | |
| NSD Learning | 100% | | | | 224100 | |

* Assumed that the gain value is already known.

Table 6 shows two data sets for the red and green classes, and is shown by graph 1200a of FIG. 12. After CEP learning, two DNDFs 1210 and 1220 were obtained as shown by graph 1200b, and the corresponding performance results with 100% correct learning are shown by graph 1200c. Graph 1200c shows a DB that is correctly labelled after the learning process.

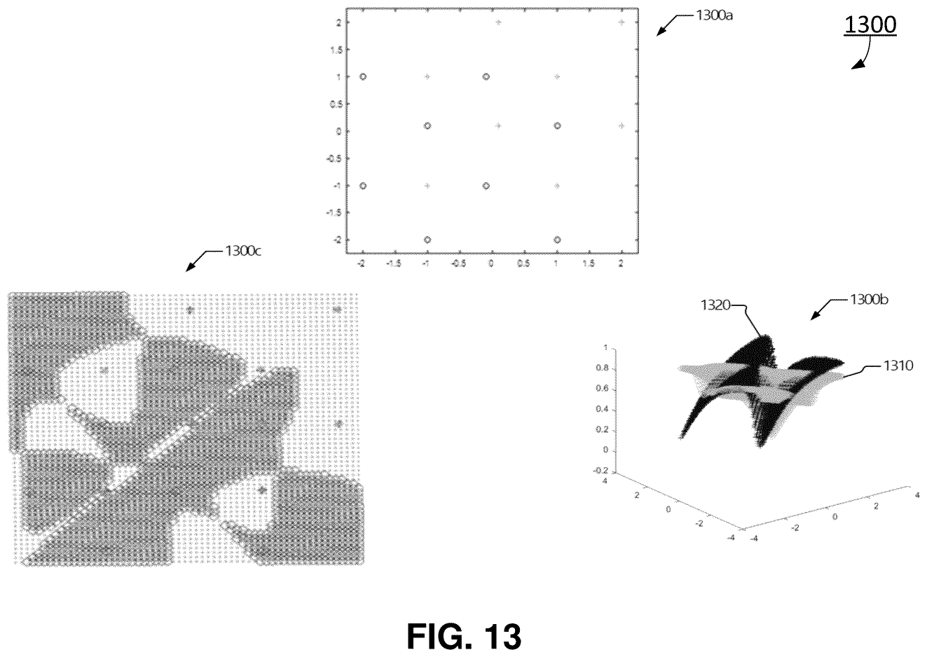

FIG. 13 shows aspects of a second NSD study that was performed to show that dynamic supervised learning (DSL) is well suited to autonomous learning when the training data sets are not well separable, as is shown by graph 1300a.

TABLE 8
Sample data for Non-Linear Sample Data

| | | | | | | | |
|---|---|---|---|---|---|---|---|
| Class Red (X, Y) | 0.10 | 1.00 | 2.00 | −1.00 | 0.10 | −1.00 | 2.00 |
| | 0.10 | 1.00 | 2.00 | −1.00 | 2.00 | 1.00 | 0.10 |
| Class Green (X, Y) | 1.00 | −2.00 | −2.00 | −0.10 | 1.00 | −0.10 | −1.00 |
| | 0.10 | −1.00 | 1.00 | −1.00 | −2.00 | 1.00 | 0.10 |

The second NSD study included a red class data set and a green class data set based on the sample data shown by Table 8 and the performance parameters of Table 9. The red and green classes are graphically shown by graph 1300a. After CEP learning, two output decisions 1310, 1320 (also referred to DNDFs 1310, 1320) are obtained and shown by graph 1300b, the corresponding output decision surface is shown by graph 1300c as having 100% correct learning.

TABLE 9
Performance Parameter for NSD problem with RMS error = 0.01

| | | | | | Number of |
|---|---|---|---|---|---|
| | | | Neuron | Number of | compu- |
| | Correct | RMS | Gain | Hidden | tations |
| | Learning | Error | (α) | Units | (+ and *) |
| Class Red | 100% | 0.007550 | 1.997 | 10 | 325,600 |
| Class Green | 100% | 0.040712 | 1.997 | 10 | 325,600 |
| NSD Learning | 100% | | | | 651,200 |

In this example, the gain (e.g., neuron gain αᵢ) was self-iterated starting from 2.0 with a step size of 0.001, which required four iterations of gain to reach to 1.997. Starting from a gain of 2.0, the DNDF architectures 300, 400 was able to find the solution at a gain of 1.997 with step size of 0.001. The total time for the feedback DSL is 2,604,800 (4*651,200) computations.

### 1.1.4. Example Simulations

A simulation of 100 trials was performed with different seeds and on average, and included two classes, namely class A and class B. In this simulation, class A required 9.12 hidden units and class B required 9.6 hidden units. The total time for the feedback DSL was 2,356,280 computations. This demonstrates that DSL with a feedback loop is able to classify non-separable datasets without manned intervention, indicating that the DSL is capable of autonomous learning. This simulation shows its superiority for autonomy of the DNDFs 300, 400 discussed herein over backprop and kernel SVM (KSVM), which are techniques in a nonlinear separable data set with manned interference. From the unknown environment, the feedback network (e.g., DNDF architecture 400 of FIG. 4) to learn in a loop with the change of learning activation from high to low until the learning performs 100% correct.

### 1.1.4.1. Fast Learning for Object Recognition

Another simulation was performed using 201 images of human faces and sampled 1 positions within each face. Each image had a 100×100 pixel resolution array from which each position image is a 96×96 pixel array. Three features were used for prediction including periphery, fovea, and LGN for each image (see e.g., U.S. application Ser. No. 14/986,572 filed on 31 Dec. 2015 now U.S. Pat. No. 9,846,808, and U.S. application Ser. No. 14/986,057 filed on 31 Dec. 2015 now U.S. Pat. No. 10,133,955, the contents of each of which are hereby incorporated by reference in their entireties). The total image features to be trained included a 9648-pixel array (96×96). The training phase of this simulation took two minutes to complete on a compute platform including an Intel® i7-6700 CPU @ 3.40 GHz processor system. Due to non-competitive training, crosstalk may affect the training results. Additionally, all training patterns were tested against each other, and appeared to perform 100% correctly. This simulation demonstrates that the DNDF architecture with feedback loop (e.g., DNDF architecture 400 of FIG. 4) is able to learn of non-linearly separable and/or linearly separable data set(s) without human intervention, which indicates the learning can be done in an autonomous fashion.

### 1.2. Additional DNDF Aspects

Unwanted Crosstalk: Since each DNDF is obtained independently with or without competing with the previous DNDFs, there is a possibility that the DNDF architecture 300, 400 may face unwanted (cross talk) intercept from other previous DNDFs, which could cause deviations in the accuracy of performance. However, the DNDF architecture 300, 400 can be equipped with a feature of NN learning which is fault tolerant. This fault tolerance eliminates cross talk by using multiple samples in the neighborhood of input sample data, such as saccadic eye movements (see e.g., Yarbus, Eye Movements and Vision, INSTITUTE FOR PROBLEMS OF INFORMATION TRANSMISSION, ACADEMY OF SCIENCES OF THE USSR, Moscow, Plenum Press, New York (1967)). The multiple samples ensure that results will be in the neighborhood of the output while the cross talk in nature cannot hold it together; hence, the average of the result guarantee to get rid of the potential crosstalk. From a biological perspective, mini-saccadic samples are used in nature (see e.g., Hubel, Eye, Brain, and Vision, 2nd Ed., W H FREEMAN & CO., SCIENTIFIC AMERICAN LIBRARY (15 May 1995)), which is consistent with the DNDF aspects discussed herein.

Root Mean Square (RMS) Error: For less dense classes tasks, the RMS error (e.g., threshold 421 discussed previously) can be set loosely. However, with a relatively dense non-linear dataset, the RMS should be set to be a relatively small value to ensure it is close to function approximation in the neighborhood of that data set. This requirement may force the DNDF architecture to be close to the learning sample data to provide better performance.

Learning Rate: CEP itself has only one learned attractor as compared to backprop, which has multiple identical learned attractors. Therefore, the sensitivity of learning is not an issue for the DNDF architectures.

### 2. Artificial Intelligence and Machine Learning Aspects

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used. ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in certain embodiments are characteristics, properties, and/or parameters for an ML process that cannot be learnt during a training process. Hyperparameters are usually set before training takes place, and may be used in processes to help estimate model parameters.

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and neural networks (NNs) in a way that mimics the working of a biological brain. An example of such an implementation is shown by FIG. 14.

FIG. 14 illustrates an example NN 1400, which may be suitable for use by one or more of the computing devices/systems (or subsystems), such as any of those discussed herein, e.g., a dynamic supervised neural distribution function machine learning system 1500 as shown in FIG. 15, implemented in whole or in part by a hardware accelerator, and/or the like. The NN 1400 may be deep neural network (DNN) used as an artificial brain of a dynamic supervised neural distribution function machine learning system or network of dynamic supervised neural distribution function machine learning systems to handle very large and complicated observation spaces. Additionally or alternatively, the NN 1400 can be arranged in any suitable topology (or combination of topologies), such as an associative NN, autoencoder, Bayesian NN (BNN), dynamic BNN (DBN), Cascade Error Projection (CEP) NN (e.g., CEP NN architecture 100 of FIG. 1), compositional pattern-producing network (CPPN), convolution NN (CNN), deep Boltzmann machines, restricted Boltzmann machine (RBM), deep belief NN, deconvolutional NN (DNN), feed forward NN (FFN), deep predictive coding network (DPCN), deep stacking NN, a dynamic neural distribution function NN (see e.g., DNDF architecture 300 and/or 400 of FIGS. 3 and 4), encoder-decoder network, energy-based generative NN, generative adversarial network (GAN), graph NN (GNN), multilayer perceptron (MLP) NN, perception NN, linear dynamical system (LDS), switching LDS (SLDS), Markov chain, multilayer kernel machines (MKM), neural Turing machine, optical NN, radial basis function, recurrent NN (RNN), long short term memory (LSTM) network, gated recurrent unit (GRU), echo state network (ESN), reinforcement learning (RL) NN, self-organizing feature map (SOFM), spiking NN, transformer NN, attention NN, self-attention NN, time delay NN, among many others including variants of any of the aforementioned topologies/algorithms. Additionally or alternatively, the NN 1400 (or multiple NNs 1400) of any combination of the aforementioned topologies can be arranged in an ML pipeline or ensemble learning configuration or arrangement. Additionally or alternatively, the NN 1400 may represent a subnet that is part of a larger supernet, or the NN 1400 may represent a supernet that comprises one or more smaller subnets. Furthermore, the NN 1400 can be trained using a suitable supervised learning technique, or can be used for unsupervised learning and/or RL.

The NN 1400 may encompass a variety of ML techniques where a collection of connected artificial neurons 1410 that (loosely) model neurons in a biological brain that transmit signals to other neurons/nodes 1410. The neurons 1410 may also be referred to as nodes 1410, processing elements (PEs) 1410, or the like. The connections 1420 (or edges 1420) between the nodes 1410 are (loosely) modeled on synapses of a biological brain and convey the signals between nodes 1410. Note that not all neurons 1410 and edges 1420 are labeled in FIG. 14 for the sake of clarity.

Each neuron 1410 has one or more inputs and produces an output, which can be sent to one or more other neurons 1410 (the inputs and outputs may be referred to as “signals”). Inputs to the neurons 1410 of the input layer Lₓ can be feature values of a sample of external data (e.g., input variables xᵢ). The input variables xᵢ can be set as a vector containing relevant data (e.g., observations, ML features, and the like). The inputs to hidden units 1410 of the hidden layers Lₐ, L_{b}, and L_{c} may be based on the outputs of other neurons 1410. The outputs of the final output neurons 1410 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 1410 may have a threshold such that a signal is sent only if the aggregate signal crosses that threshold. A node 1410 may include an activation function, which defines the output of that node 1410 given an input or set of inputs. Additionally or alternatively, a node 1410 may include a propagation function that computes the input to a neuron 1410 from the outputs of its predecessor neurons 1410 and their connections 1420 as a weighted sum. A bias term can also be added to the result of the propagation function.

The NN 1400 also includes connections 1420, some of which provide the output of at least one neuron 1410 as an input to at least another neuron 1410. Each connection 1420 may be assigned a weight that represents its relative importance. The weights may also be adjusted as learning proceeds. The weight increases or decreases the strength of the signal at a connection 1420.

The neurons 1410 can be aggregated or grouped into one or more layers L where different layers L may perform different transformations on their inputs. In FIG. 14, the NN 1400 comprises an input layer Lₓ, one or more hidden layers Lₐ, L_{b}, and L_{c}, and an output layer L_{y} (where a, b, c, x, and y may be numbers), where each layer L comprises one or more neurons 1410. Signals travel from the first layer (e.g., the input layer L₁), to the last layer (e.g., the output layer L_{y}), possibly after traversing the hidden layers Lₐ, L_{b}, and L_{c} multiple times. In FIG. 14, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 14, for simplicity of illustration, there are only three hidden layers Lₐ, L_{b}, and L_{c} in the NN 1400, however, the NN 1400 may include many more (or fewer) hidden layers Lₐ, L_{b}, and L_{c} than are shown.

In certain embodiments, the NN 1400 can be implemented as a perceptron. A perceptron is an NN comprising a set of units (e.g., neurons 1410), where each unit can receive an input from one or more other units. Each unit takes the sum of all values received and decides whether it is going to forward a signal on to one or more other units to which it is connected according to the node's activation function. In this example, the perceptron includes a single layer of input units including one bias unit as the activation function and a single output unit, wherein any number of input units can be included. The bias unit may shift the DB away from the origin and may not depend on any input value. Additionally or alternatively, one or more of the neurons 1410 can be a perceptron, where the perceptrons use the Heaviside step function as the activation function.

### 3. Hardware and Software Systems, Configurations, and Arrangements

In one aspect, an exemplary dynamic supervised neural distribution function machine learning system 1500 for implementing the techniques (e.g., operations, processes, methods, and methodologies) is shown in FIG. 15 according to certain embodiments of the present disclosure. In certain embodiments, the dynamic supervised and neural distribution machine learning system 1500 includes: a sensory circuitry 1510, an input and output device 1520, and a dynamic supervised and neural distribution machine learning system controller 1530.

In certain embodiments, the sensory circuitry 1510 generates a set of input patents for the dynamic supervised and neural distribution machine learning system controller 101 to perform machine learning. The input and output device 1520 receives the set of input patents from the sensor circuitry 1510 and transmits the set of input patents received to the dynamic supervised and neural distribution machine learning system controller 1530 for processing.

The dynamic supervised neural distribution function machine learning system 1500 can include any combination of the hardware or logical components referenced herein, and may include or couple with any device usable with a communication network or a combination of such networks. In particular, any combination of the components depicted by FIG. 15 can be implemented as individual ICs, discrete electronic devices, or other modules, instruction sets, programmable logic or algorithms, hardware, hardware accelerators, software, firmware, or a combination thereof adapted in the dynamic supervised neural distribution function machine learning system 1500, or as components otherwise incorporated within a chassis of a larger system. Additionally or alternatively, any combination of the components depicted by FIG. 15 can be implemented as a system-on-chip (SoC), a single-board computer (SBC), a system-in-package (SiP), a multi-chip package (MCP), and/or the like, in which a combination of the hardware elements are formed into a single IC or a single package.

The dynamic supervised neural distribution function machine learning system 1500 includes physical hardware devices and software components capable of providing and/or accessing content and/or services to/from a remote system. The dynamic supervised neural distribution function machine learning system 1500 can be implemented as any suitable computing system or other data processing apparatus usable to access and/or provide content/services from/to one another. As examples, the dynamic supervised neural distribution function machine learning system 1500 can be embodied as desktop computers, workstations, laptops, mobile phones (e.g., “smartphones”), tablet computers, portable media players, wearable devices, server(s), network appliances, smart appliances or smart factory machinery, network infrastructure elements, robots, drones, sensor systems and/or IoT devices, cloud dynamic supervised neural distribution function machine learning systems, edge dynamic supervised neural distribution function machine learning systems, an aggregation of computing resources (e.g., in a cloud-based environment). For purposes of the present disclosure, the dynamic supervised neural distribution function machine learning system 1500 may represent any of the computing devices discussed herein, and/or may correspond to, or include one or more of the CEP architecture 100, DNDF architecture 300, DNDF architecture 400, the NN 1400, and/or any other devices or systems, such as any of those discussed herein.

The dynamic supervised neural distribution function machine learning system 1500 includes physical hardware devices and software components capable of providing and/or accessing content and/or services to/from any remote systems.

In certain embodiments, the dynamic supervised and neural distribution machine learning system controller 1530 includes: a processor 15301, a DDR RAM 15302, and a non-volatile memory 15303. The DDR RAM 1012 supports operations of the processor 15301, the non-volatile memory 15303 stores an operating system 153031, and computer executable instructions 153032. The computer executable instructions 153032 includes a Neural Distribution Functions Module 1530321, a Competition Function Module 1530322, a Comparator Module 1530323, and a Gain Adjuster Module 1530324. When executed on the processor 15301, the computer executable instructions 153032 cause the processor 15301 to perform one or more of flowing operations:

In certain embodiments, the processor 15301 includes circuitry capable of sequentially and/or automatically carrying out a sequence of arithmetic or logical operations, and recording, storing, and/or transferring digital data. Additionally or alternatively, the processor 15301 includes any device capable of executing or otherwise operating computer-executable instructions, such as program code, software modules, and/or functional processes. The processor 15301 includes various hardware elements or components such as, for example, a set of processor cores and one or more of on-chip or on-die memory or registers, cache and/or scratchpad memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports.

In certain embodiments, the processor 15301 can be embodied as, or otherwise include one or multiple central processing units (CPUs), application processors, graphics processing units (GPUs), RISC processors, Acorn RISC Machine (ARM) processors, complex instruction set computer (CISC) processors, DSPs, FPGAs, programmable logic devices (PLDs), ASICs, baseband processors, radio-frequency integrated circuits (RFICs), microprocessors or controllers, multi-core processors, multithreaded processors, ultra-low voltage processors, embedded processors, a specialized x-processing units (xPUs) or a data processing unit (DPUs) (e.g., Infrastructure Processing Unit (IPU), network processing unit (NPU), and the like), neural compute chips/processors, probabilistic RAM (“pRAM” or “p-ram”) neural processors, stochastic processors, quantum processors, and/or any other processing devices or elements, or any combination thereof. In some implementations, the processor 15301 is embodied as one or more special-purpose processor(s)/controller(s) configured (or configurable) to operate according to the various implementations and other aspects discussed herein. Additionally or alternatively, the processor 15301 includes one or more hardware accelerators, which can include microprocessors, programmable processing devices (e.g., FPGAs, ASICs, PLDs, DSPs. and/or the like), and/or the like. As examples, the processor 15301 may include Intel® Core™ based processor(s), MCU-class processor(s), Xeon® processor(s); Advanced Micro Devices (AMD) Zen® Core Architecture processor(s), such as Ryzen® or Epyc® processor(s), Accelerated Processing Units (APUs), MxGPUs, or the like; A, S, W, and T series processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); Power Architecture processor(s) provided by the OpenPOWER® Foundation and/or IBM®, MIPS Warrior M-class, Warrior I-class, and Warrior P-class processor(s) provided by MIPS Technologies, Inc.; ARM Cortex-A, Cortex-R, and Cortex-M family of processor(s) as licensed from ARM Holdings, Ltd.; the ThunderX2® provided by Cavium™, Inc.; GeForce®, Tegra®, Titan X®, Tesla®, Shield®, and/or other like GPUs provided by Nvidia®; or the like. Other examples of the processor 15301 may be mentioned elsewhere in the present disclosure.

In certain embodiments, the non-volatile memory 15303 stores an operating system (OS) 153031 and computer executable instructions 153032 to control various aspects of the dynamic supervised neural distribution function machine learning system 1500. The OS 153031 can include drivers and/or APIs to control particular devices or components that are embedded in the dynamic supervised neural distribution function machine learning system 1500, attached to the dynamic supervised neural distribution function machine learning system 1500, communicatively coupled with the dynamic supervised neural distribution function machine learning system 1500, and/or otherwise accessible by the dynamic supervised neural distribution function machine learning system 1500. The OSs also include one or more libraries, drivers, APIs, firmware, middleware, software glue, and the like, which provide program code and/or software components for one or more apps to obtain and use the data from other apps operated by the dynamic supervised neural distribution function machine learning system 1500, such as the various subsystems of the CEP NN architecture 100 and/or DNDF architecture 300, 400, and/or any other device or system discussed herein. For example, the OS can include a display driver to control and allow access to a display device, a touchscreen driver to control and allow access to a touchscreen interface of the system 1500, sensor drivers to obtain sensor readings of the sensor circuitry 1510 and control and allow access to sensor circuitry 1510. Example OSs include consumer-based OS (e.g., Microsoft® Windows® 10, Google® Android®, Apple® macOS®, Apple® iOS®, KaiOS™ provided by KaiOS Technologies Inc., Unix or a Unix-like OS such as Linux, Ubuntu, or the like), industry-focused OSs such as real-time OS (RTOS) (e.g., Apache® Mynewt, Windows® IoT®, Android Things®, Micrium® Micro-Controller OSs (“MicroC/OS” or “μC/OS”), VxWorks®, FreeRTOS, and/or the like), hypervisors (e.g., Xen® Hypervisor, Real-Time Systems® RTS Hypervisor, Wind River Hypervisor, VMWare® vSphere® Hypervisor, and/or the like), and/or the like. For purposes of the present disclosure, can also include hypervisors, container orchestrators and/or container engines. The OS can invoke alternate software to facilitate one or more functions and/or operations that are not native to the OS, such as particular communication protocols and/or interpreters. Additionally or alternatively, the OS instantiates various functionalities that are not native to the OS. In certain embodiments, OSs include varying degrees of complexity and/or capabilities. In certain embodiments, a first OS on a first dynamic supervised neural distribution function machine learning system 1500 may be the same or different than a second OS on a second dynamic supervised neural distribution function machine learning system 1500 (here, the first and second dynamic supervised neural distribution function machine learning systems 1500 can be physical machines or VMs operating on the same or different physical dynamic supervised neural distribution function machine learning systems). In these examples, the first OS may be an RTOS having particular performance expectations of responsivity to dynamic input conditions, and the second OS can include GUI capabilities to facilitate end-user I/O and the like.

In certain embodiments, the input and output device 1520 includes input device circuitry and output device circuitry. The input device circuitry includes one or more user interfaces designed to enable user interaction with the dynamic supervised neural distribution function machine learning system 1500 and/or peripheral component interfaces designed to enable peripheral component interaction with the dynamic supervised neural distribution function machine learning system 1500. In certain embodiments, the input and output device 1520 receives the set of input patents from the sensor circuitry 1510 and transmits the set of input patents received to the dynamic supervised and neural distribution machine learning system controller 1530 for processing.

In certain embodiments, the input device circuitry includes any physical or virtual means for accepting an input including, inter alia, one or more physical or virtual buttons, a physical or virtual keyboard, keypad, mouse, touchpad, touchscreen, microphones, scanner, headset, and/or the like. In implementations where the input device circuitry includes a capacitive, resistive, or other like touch-surface, a touch signal may be obtained from circuitry of the touch-surface. The touch signal may include information regarding a location of the touch (e.g., one or more sets of (x,y) coordinates describing an area, shape, and/or movement of the touch), a pressure of the touch (e.g., as measured by area of contact between a user's finger or a deformable stylus and the touch-surface, or by a pressure sensor), a duration of contact, any other suitable information, or any combination of such information. In these implementations, one or more apps operated by the processor circuitry 1501 may identify gesture(s) based on the information of the touch signal, and utilizing a gesture library that maps determined gestures with specified actions.

In certain embodiments, the output device circuitry is used to show or convey information, such as sensor readings, actuator position(s), or other like information. Data and/or graphics may be displayed on one or more user interface components of the output device circuitry. The output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED and/or OLED displays, quantum dot displays, projectors, and the like), with the output of characters, graphics, multimedia objects, and the like being generated or produced from operation of the dynamic supervised neural distribution function machine learning system 1500. The output device circuitry may also include speakers or other audio emitting devices, printer(s), and/or the like. In some implementations, the sensor circuitry 1510 may be used as the input device circuitry (e.g., an image capture device, motion capture device, or the like). In another embodiment, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a universal serial bus (USB) port, an audio jack, a power supply interface, and the like.

In certain embodiments, when executed on the processor 15301, the computer executable instructions 153032 cause the processor 15301 to perform one or more of flowing operations:
generating, by the Neural Distribution Functions Module 1530321, a set of neural distribution functions (NDFs) that are independent of one another, wherein during each iteration of a learning process until convergence is reached, each NDF in the set of NDFs receives an input pattern from the sensor circuitry 1510 through the input and output device 1520 and generates a candidate output in a set of candidate outputs based on the input pattern;
selecting, by the Competition Function Module 1530322 connected to the set of NDFs, a candidate output from among the set of candidate outputs during each iteration;
comparing, by the Comparator Module 1530323, the selected candidate output with a target pattern to obtain an error value;
adjusting, by the Gain Adjuster Module 1530324 connected to the comparator and the set of NDFs, respective neural gains of corresponding NDFs in the set of NDFs when the error value is greater than a threshold;
and feeding, by the Gain Adjuster Module 1530324 connected to the comparator and the set of NDFs, the adjusted neural gains to the corresponding NDFs, wherein the adjusted neural gains are for generation of a next set of candidate outputs during a next iteration of the learning process.

In certain embodiments, the set of NDFs are learned independently of one another using a cascade error projection (CEP) learning algorithm as shown in FIG. 1.

FIG. 1 depicts an example CEP NN architecture 100 that includes a set of inputs 101 (e.g., including X₁ to Xₙ belonging to an input pattern X^{p}), a set of learned frozen weights 102 (also referred to as “learned frozen weight set 105” or the like), a previous hidden unit 110, a learned weight block 115, a current hidden unit 120, a set of calculated frozen weights 125 (also referred to as “calculated frozen weight set 125” or the like), a set of calculated weights 130, a set of neuron activation functions 133-1 to 133-m (where m is a number), and a set of output units 135. In the following discussion, the set of learned frozen weights 102 is denoted as Wᵢₕ₍ₙ₎, the learned weight block 115 is denoted as Wᵢₕ₍ₙ₊₁₎, the set of calculated frozen weights 125 is denoted as Wᵢₙ or Wᵢₒ, the set of calculated weights 130 is denoted as Wₕₒ₍ₙ₊₁₎ or Wₕₒ₍ₙ₊₁₎, and the set of output units 135 is denoted as

$$( {O}_{l}^{p} , … , {O}_{m}^{p} )$$

or Oᵢ. In FIG. 1, the shaded circles are a learned weights that is/are frozen (Wᵢₕ₍ₙ₎), the unshaded (open) circles are learned weights (Wᵢₕ₍ₙ₊₁₎), the shaded squares are calculated weights that are computed and frozen (Wᵢₙ), and the unshaded (open) squares are calculated weights (Wₕₒ₍ₙ₊₁₎). In particular, the circles indicate that learning is applied to obtain the weight set using perceptron learning, and squares indicate that the weight set is deterministically calculated Additionally, the unshaded (open) circles and squares are weight components that determine the weight values by learning or calculation.

In certain embodiments, the weights Wᵢₕ₍ₙ₎ are learned from a frozen NN and/or the weights Wᵢₕ₍ₙ₎ are frozen during a training process. Here, the weights Wᵢₕ₍ₙ₎ are learned from previous frozen hidden units and it inputs, and then the weights Wᵢₕ₍ₙ₎ are frozen at the end of that training process. A frozen NN is one in which only portion of the NN's parameters are trained and the remaining parameters are frozen at their initial (pre-trained) values, leading to faster convergence and a reduction in the resources consumed during the training process. By freezing the weights, the number of trainable parameters is shrunken which reduces gradient computations and the dimensionality of the model's optimization space. As examples, weight set Wᵢₕ₍ₙ₎ can be frozen and/or learned according to any suitable freezing technique, such as any of those discussed in Wimmer et al., Dimensionality Reduced Training by Pruning and Freezing Parts of a Deep Neural Network, a Survey, arXiv: 2205.08099v1 [cs.LG] (17 May 2022), the contents of which is hereby incorporated by reference in its entirety.

The CEP NN architecture 100 includes two sub-networks, including a first sub-network that uses perception (perceptron) learning (e.g., a primary network) and a second sub-network that uses deterministic calculations (e.g., a secondary network). In this example, the first sub-network corresponds to the calculated frozen weight set 125, and the second sub-network corresponds to the current hidden unit 120. The architecture 100 starts out as a single layer perception and adds hidden units when needed, one after another. The network contains n hidden units and the learning cannot be improved any further in the energy level. At this point, a new hidden unit (e.g., n+1) is added to the network. Additionally, N is the dimension of the input space, n+1 is the dimension of the expanded input space (e.g., n+1 is dynamically changed and is based on the learning requirement), m is the dimension of the output space, P is the number of training patterns, and f is a sigmoidal transfer function which is defined by equation (5). Additionally or alternatively, each of the neuron activation functions 133-1 to 133-m (collectively referred to as “neuron activation functions 133” or “neuron activation function 133”) may be logistic and/or sigmoidal activation functions (e.g., which may be the same or similar as the sigmoidal transfer function f), or some other type of activation function, such as any of those discussed herein). Additionally or alternatively, the neuron activation functions 133 may have the same or similar activation functions as the hidden units. Other notions are summarized in Table 1, infra.

An energy function for the CEP NN architecture 100 is defined by equation (1), and equation (2) denotes the error for output index o and training pattern p between target t and the actual output o(n), wherein n indicates the output with n hidden units in the network.

$$E ( n + 1 ) = {\sum }_{p = 1}^{P} {\{ {f}_{h}^{P} ( n + 1 ) - \frac{1}{m} {\sum }_{o = 1}^{m} ( {t}_{o}^{P} - {O}_{o}^{P} ) \}}^{2} \qquad ( 1 )$$

$${ε}_{o}^{P} = {t}_{o}^{P} - {O}_{o}^{P} ( n ) \qquad ( 2 )$$

The weight update between the inputs (including previously added or expanded hidden units) and the newly added hidden unit is calculated as shown by equation (3).

$$Δ {w}_{ih}^{P} ( n + 1 ) = - η \frac{\partial E ( n + 1 )}{\partial {w}_{ih}^{P} ( n + 1 )} \qquad ( 3 )$$

Additionally, the weight updates between hidden unit n+1 (or hidden unit h) and the output unit o is shown by equation (4) with the sigmoidal transfer function which is defined by equation (5).

$${w}_{ho} ( n + 1 ) = \frac{{\sum }_{p = 1}^{P} {ε}_{o}^{P} {f}_{o}^{′ p} {f}_{h}^{p} ( n + 1 )}{{{\sum }_{p = 1}^{P} [ {f}_{o}^{′ p} {f}_{h}^{p} ( n + 1 ) ]}^{2}} \qquad ( 4 )$$

$$f ( x ) = \frac{1 - {e}^{- x}}{1 + {e}^{- x}} \qquad ( 5 )$$

Notations used in equations (1), (2), (3), (4), (5), (6), (7), (8) are summarized by Table 1.

TABLE 1

| Parameter | Description |
|---|---|
| E | energy function |
| ${ε}_{o}^{P}$ | Error output index o and training pattern p between target t and the actual output o(n) (see equation (2), supra) |
| f | sigmoidal transfer function which is defined by equation (5), supra |
| ${f}_{h}^{P}$ | sigmoidal transfer function for training pattern p and hidden unit h |
| ${f}_{o}^{′ p} ( n ) = {f}_{o}^{′ p}$ | an output transfer function derivative with respect to its input index o and training pattern p |
| ${f}_{h}^{p} ( n + 1 )$ | a transfer function of hidden unit n + 1 for training pattern p |
| h | hidden unit |
| ih | denotes input hidden unit |
| m | the dimension of the output space and/or the number of outputs |
| n | the number of previously added hidden units |
| n + 1 | the dimension of the expanded input space |
| N | the dimension of the input space and/or the number of input units |
| η | a learning rate, which may be a predefined or configured value |
| α | neural gain (In certain embodiments, α = η) |
| o | output unit |
| o(n) | output unit with n hidden units in the network |
| ${O}_{o}^{P} ( n )$ | output element o of the actual output o(n) for training pattern p |
| p | a training pattern currently being processed (e.g., a “subject training |
| | pattern”) |
| P | the number of training patterns |
| t | a target (also referred to as “target element”) |
| ${t}_{o}^{P}$ | target element of output unit o for input training pattern p |
| $Δ {w}_{ih}^{P}$ | The weight update between inputs including previously added hidden units n and the newly added hidden unit n + 1 |
| Wᵢₙ | calculated weights that are frozen |
| Wᵢₕ₍ₙ₎ | learned weights that are frozen for hidden unit n |
| Wᵢₕ₍ₙ₊₁₎ | learned weights that are frozen for hidden unit n + 1 |
| Wₕₒ | calculated weights |
| Wₕₒ₍ₙ₊₁₎ | calculated weights at n + 1 |
| Xₙ | denotes the input of hidden unit n |
| X^{p} | denotes the input pattern p or a p-dimensional vector |

In some implementations, the CEP learning algorithm is processed in two steps wherein a first step includes single perceptron learning, and a second step includes obtaining the weight set Wₕₒ₍ₙ₊₁₎. The single perceptron learning is governed by equation (3) to update the weight vector Wᵢₕ₍ₙ₊₁₎ (step 1). When the single perceptron learning is completed, the weight set Wₕₒ₍ₙ₊₁₎ can be obtained by the calculation governed by equation (4) (step 2). An exemplary CEP learning procedure is shown by FIG. 2.

FIG. 2 shows an exemplary CEP learning procedure 200, which may be performed by a dynamic supervised neural distribution function machine learning system, as shown in FIG. 15. The CEP learning procedure 200 starts with a neural network, which has input and output neurons (see e.g., FIG. 14). With the given input and output patterns and hyperbolic transfer function, at operation 201, the dynamic supervised neural distribution function machine learning system 1500 determines a set of weights (e.g., weight set Wᵢₒ) between the input and output using, for example, pseudo-inverse learning and/or perceptron learning. At operation 202, the dynamic supervised neural distribution function machine learning system 1500 freezes the weight set Wᵢₒ. At operation 203, the dynamic supervised neural distribution function machine learning system 1500 adds a new hidden unit with a zero weight set for each unit. In each loop (contains an epoch) an input-output pattern is picked up randomly in the epoch (no pattern is repeated until every pattern in the epoch is pick). At operation 204, the dynamic supervised neural distribution function machine learning system 1500 uses a perceptron learning technique of equation (3) to train the weight set Wᵢₕ₍ₙ₊₁₎ for a predetermined or configured number of loops (e.g., 100 loops). At operation 205, the dynamic supervised neural distribution function machine learning system 1500 stops the perception training and calculate the weight(s) Wₕₒ₍ₙ₊₁₎ between the current hidden unit n and the output units from equation (4). At operation 206, the dynamic supervised neural distribution function machine learning system 1500 performs a cross-validation of the network, and determines if the criteria is satisfied. If so, the procedure 200 ends. Otherwise, the dynamic supervised neural distribution function machine learning system 1500 proceeds back to operation 203. In some examples, the dynamic supervised neural distribution function machine learning system 1500 loops back to operation 203 until the number of hidden units is more than a predefined or configured amount (e.g., 20) and then terminations the procedure 200.

In certain embodiments, each NDF in the set of NDFs includes a decision boundary (DB), and each NDF is configured to classify data according to its DB.

In certain embodiments, each NDF is configured to generate the candidate output to include its DB and one or more classified datasets.

In certain embodiments, the DB of each NDF is derived using the CEP learning algorithm.

In certain embodiments, the set of NDFs are individual sub-networks that are part of a super-network, and wherein the learning process is: a training phase for training the super-network, wherein the input pattern and the target pattern are part of a training dataset; or the learning process is a testing phase for testing and validating the super-network, wherein the input pattern and the target pattern are part of a test dataset.

In certain embodiments, the super-network is a neural network (NN) including one or more of an associative NN, autoencoder, Bayesian NN (BNN), dynamic BNN (DBN), CEP NN, compositional pattern-producing network, convolution NN (CNN), deep CNN, deep Boltzmann machine, restricted Boltzmann machine, deep belief NN, deconvolutional NN, feed forward NN (FFN), deep predictive coding network, deep stacking NN, dynamic neural distribution function NN, encoder-decoder network, energy-based generative NN, generative adversarial network, graph NN, multilayer perceptron, perception NN, linear dynamical system (LDS), switching LDS, Markov chain, multilayer kernel machines, neural Turing machine, optical NN, radial basis function, recurrent NN, long short term memory network, gated recurrent unit, echo state network, reinforcement learning NN, self-organizing feature map, spiking NN, transformer NN, attention NN, self-attention NN, and time delay NN.

In certain embodiments, the competition function includes one or more of a maximum function, a minimum function, a folding function, a radial function, a ridge function, softmax function, a maxout function, an arg max function, an arg min function, a ramp function, an identity function, a step function, a Gaussian function, a logistic function, a sigmoid function, and a transfer function.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A dynamic supervised and neural distribution machine learning system comprising:
a sensor circuitry 11 for generating a set of input patents for the dynamic supervised and neural distribution machine learning system controller 101;
an input and output device 12 for receiving the set of input patents from the sensor circuitry 11 and providing the set of input patents received to the dynamic supervised and neural distribution machine learning system controller 101;
a processor 1011, a DDR RAM 1012, and a non-volatile memory 1013, wherein the DDR RAM 1012 supports operations of the processor 1011, the non-volatile memory 1013 stores an operating system 10131, and computer executable instructions 10132, wherein the computer executable instructions 10132 comprise a Neural Distribution Functions Module 101321, a Competition Function Module 101322, a Comparator Module 101323, and a Gain Adjuster Module 101324, when executed on the processor 1011, the computer executable instructions 10132 cause the processor 1011 to perform:
generating, by the Neural Distribution Functions Module 101321, a set of neural distribution functions (NDFs) that are independent of one another, wherein during each iteration of a learning process until convergence is reached, each NDF in the set of NDFs receives an input pattern from a sensor circuitry 11 through an input/output device 12 and generates a candidate output in a set of candidate outputs based on the input pattern;
selecting, by the Competition Function Module 101322 connected to the set of NDFs, a candidate output from among the set of candidate outputs during each iteration;
comparing, by the Comparator Module 101323, the selected candidate output with a target pattern to obtain an error value;
adjusting, by the Gain Adjuster Module 101324 connected to the comparator and the set of NDFs, respective neural gains of corresponding NDFs in the set of NDFs when the error value is greater than a threshold;
and feeding, by the Gain Adjuster Module 101324 connected to the comparator and the set of NDFs, the adjusted neural gains to the corresponding NDFs, wherein the adjusted neural gains are for generation of a next set of candidate outputs during a next iteration of the learning process.

2. The dynamic supervised and neural distribution machine learning system of claim 1, wherein the set of NDFs are learned independently of one another using a cascade error projection (CEP) learning algorithm.

3. The dynamic supervised and neural distribution machine learning system of claim 2, wherein each NDF in the set of NDFs includes a decision boundary (DB), and each NDF is configured to classify data according to its DB.

4. The dynamic supervised and neural distribution machine learning system of claim 3, wherein each NDF is configured to generate the candidate output to include its DB and one or more classified datasets.

5. The dynamic supervised and neural distribution machine learning system of claim 3, wherein the DB of each NDF is derived using the CEP learning algorithm.

6. The dynamic supervised and neural distribution machine learning system of claim 1, wherein the set of NDFs are individual sub-networks that are part of a super-network, and wherein the learning process is: a training phase for training the super-network, wherein the input pattern and the target pattern are part of a training dataset; or the learning process is a testing phase for testing and validating the super-network, wherein the input pattern and the target pattern are part of a test dataset.

7. The dynamic supervised and neural distribution machine learning system of claim 6, wherein the super-network is a neural network (NN) including one or more of an associative NN, autoencoder, Bayesian NN (BNN), dynamic BNN (DBN), CEP NN, compositional pattern-producing network, convolution NN (CNN), deep CNN, deep Boltzmann machine, restricted Boltzmann machine, deep belief NN, deconvolutional NN, feed forward NN (FFN), deep predictive coding network, deep stacking NN, dynamic neural distribution function NN, encoder-decoder network, energy-based generative NN, generative adversarial network, graph NN, multilayer perceptron, perception NN, linear dynamical system (LDS), switching LDS, Markov chain, multilayer kernel machines, neural Turing machine, optical NN, radial basis function, recurrent NN, long short term memory network, gated recurrent unit, echo state network, reinforcement learning NN, self-organizing feature map, spiking NN, transformer NN, attention NN, self-attention NN, and time delay NN.

8. The dynamic supervised and neural distribution machine learning system of claim 1, wherein the competition function includes one or more of a maximum function, a minimum function, a folding function, a radial function, a ridge function, softmax function, a maxout function, an arg max function, an arg min function, a ramp function, an identity function, a step function, a Gaussian function, a logistic function, a sigmoid function, and a transfer function.
